(19) United States
(12) Patent Application Publication
(10) Pub. No.: US 2025/0074283 A1
(43) Pub. Date: Mar. 6, 2025

(54) ADJUSTABLE VEHICLE SEAT

(71) Applicant: Camaco, LLC, Farmington Hills, MI (US)

(72) Inventors: Jeffrey Carroll, West Bloomfield, MI (US); Ashok Singh, Farmington Hills, MI (US); Manoj Srivastava, Novi, MI (US)

(73) Assignee: Camaco, LLC, Farmington Hills, MI (US)

(21) Appl. No.: 18/824,193

(22) Filed: Sep. 4, 2024

Related U.S. Application Data
(60) Provisional application No. 63/580,810, filed on Sep. 6, 2023.

(51) Int. Cl. B60N 3/06; B60N 2/005; B60N 2/12; B60N 2/62; B60N 2/68

(52) U.S. Cl. CPC B60N 3/063; B60N 2/005; B60N 2/12; B60N 2/68; B60N 2/62

(57) ABSTRACT

An adjustable lounge seat includes a seat frame having a front end and a rear end, a back frame pivotably coupled to the rear end of the seat frame, a first assembly coupled to the seat frame proximate the rear end thereof and configured to couple to a track assembly where the first assembly is configured to facilitate moving the rear end of the seat frame up and down, a second assembly coupled to the seat frame proximate the front end thereof and configured to couple to the track assembly where the second assembly is configured to facilitate moving the front end of the seat frame up and down, and a footrest coupled to the front end of the seat frame and the second assembly where the footrest is movable between a stowed orientation and an extended orientation.

### CROSS-REFERENCE TO RELATED PATENT APPLICATION

This application claims the benefit of and priority to U.S. Provisional Patent Application No. 63/580,810, filed Sep. 6, 2023, which is incorporated herein by reference in its entirety.

### BACKGROUND

The present application relates to vehicle seats, and more specifically to vehicle seats with enhanced adjustability for providing better comfort for occupants of such seats. A vehicle seat may provide several standard forms of adjustment such as forward/backward positioning of the seat and reclining of the seat back. However, an occupant may need to occupy the vehicle seat for an extended period of time while not operating the vehicle. For example, a delivery driver may need to occupy the seat while waiting between deliveries, an electric vehicle driver may need to occupy the seat while waiting for the electric vehicle to charge, a driver of a taxi, ride share vehicle, limousine, etc. may need to occupy the seat while waiting between driving events, etc. However, in vehicles with traditional seats, the occupant may not be comfortable over an extended period of time only using the standard forms of adjustment. Therefore, it would be advantageous to provide a vehicle seat or a modular kit to modify an existing vehicle seat that improves comfort over extended periods of time.

### SUMMARY

One embodiment relates to an adjustable lounge seat for a vehicle. The adjustable lounge seat includes a seat frame having a front end and a rear end, a back frame pivotably coupled to the rear end of the seat frame, a first assembly coupled to the seat frame proximate the rear end thereof and configured to couple to a track assembly where the first assembly is configured to facilitate moving the rear end of the seat frame up and down, a second assembly coupled to the seat frame proximate the front end thereof and configured to couple to the track assembly where the second assembly is configured to facilitate moving the front end of the seat frame up and down, a footrest coupled to the front end of the seat frame and the second assembly where the footrest is movable between a stowed orientation and an extended orientation, and an actuator configured to actuate the second assembly and, thereby, the footrest.

Another embodiment relates to an adjustable lounge seat for a vehicle. The adjustable lounge seat includes a seat frame assembly configured to couple to a track assembly. The seat frame assembly includes a seat frame having a front end and a rear end, a back frame pivotably coupled to rear end of the seat frame, a first assembly coupled to the seat frame proximate the rear end thereof and configured to couple to the track assembly, a second assembly coupled to the seat frame proximate the front end thereof and configured to couple to the track assembly, and a footrest coupled to the front end of the seat frame. The first assembly is configured to facilitate moving the rear end of the seat frame up and down. The second assembly is configured to facilitate moving the front end of the seat frame up and down. The footrest is moveable between a stowed orientation and an extended orientation. The footrest includes a first bracket coupled to the second assembly, a second bracket coupled to the seat frame, a third bracket coupled to the seat frame, a linkage assembly, and a footrest support pivotably coupled to a distal end of the linkage assembly. The first bracket defines a first slot. The second bracket defines a second slot. The third bracket defines a third slot. The linkage assembly includes a plurality of linkages including at least a first set of linkages and a second set of linkages and a plurality of linkage axles including (a) a first linkage axle pivotably coupling the first set of linkages to the second set of linkages, (b) a second linkage axle pivotably coupling the first set of linkages to the second bracket and the third bracket, and (c) a third linkage axle extending through the second set of linkages and received by the first slot, the second slot, and the third slot.

Still another embodiment relates to a seat adjustment assembly. The seat adjustment assembly is (a) configured to couple to a seat frame of an adjustable lounge seat for a vehicle proximate a front end of the seat frame and (b) configured to couple to a track assembly. The seat adjustment assembly is configured to facilitate moving the front end of the seat frame up and down. The seat adjustment assembly includes a first bracket configured to couple to the track assembly, a second bracket configured to couple to the track assembly, a first linkage pivotably coupled to the first bracket, a second linkage pivotably coupled to the second bracket, a third bracket pivotably coupled to the first linkage and configured to pivotably couple to the seat frame, and a fourth bracket pivotably coupled to the second linkage and configured to pivotably couple to the seat frame.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a front perspective view of a cabin of the vehicle of FIG. 1 including seats, according to an exemplary embodiment.

FIG. 3 is a front perspective view of a frame assembly of a lounge seat, according to an exemplary embodiment.

FIG. 4 is a side view of the frame assembly of FIG. 3, according to an exemplary embodiment.

FIG. 5 is a front perspective view of the frame assembly of FIG. 3 in a base position, according to an exemplary embodiment.

FIG. 6 is a front perspective view of the frame assembly of FIG. 3 in a reclined position, according to an exemplary embodiment.

FIG. 7 is a front perspective view of the frame assembly of FIG. 3 in a forward position, according to an exemplary embodiment.

FIG. 8 is a front perspective view of the frame assembly of FIG. 3 in a rearward position, according to an exemplary embodiment.

FIG. 9 is a front perspective view of the frame assembly of FIG. 3 in a seat back angled forward position, according to an exemplary embodiment.

FIG. 10 is a front perspective view of the frame assembly of FIG. 3 in a front cushion up position, according to an exemplary embodiment.

FIG. 11 is a front perspective view of the frame assembly of FIG. 3 in a base position, according to an exemplary embodiment.

FIG. 12 is a front perspective view of the frame assembly of FIG. 3 in a lounge position, according to an exemplary embodiment.

FIG. 13 is a side perspective view of the frame assembly of FIG. 3 in a lounge position, according to an exemplary embodiment.

FIG. 14 is a front perspective view of a seat frame assembly and a track assembly of the frame assembly of FIG. 3 in a lounge position, according to an exemplary embodiment.

FIG. 15 is a detailed rear perspective view of the frame assembly of FIG. 3 in a base position, according to an exemplary embodiment.

FIG. 16 is a cross-section view of the seat frame assembly and the track assembly of FIG. 14 in the lounge position, according to an exemplary embodiment.

FIG. 17 is a front perspective view of a lower lounge lift assembly of the seat frame assembly of FIG. 14, according to an exemplary embodiment.

FIG. 18 is an exploded rear perspective view of the lower lounge lift assembly of FIG. 17, according to an exemplary embodiment.

FIG. 19 is a detailed view of a first portion of the lower lounge lift assembly of FIG. 18, according to an exemplary embodiment.

FIG. 20 is a detailed view of a second portion of the lower lounge lift assembly of FIG. 18, according to an exemplary embodiment.

FIG. 21 is a side view of the frame assembly of FIG. 3 in a lounge position with a footrest in a first position, according to an exemplary embodiment.

FIG. 22 is a side view of the frame assembly of FIG. 21 in the lounge position with the footrest in a second position, according to an exemplary embodiment.

FIG. 23 is a side view of the frame assembly of FIG. 23 in the lounge position with the footrest in a third position, according to an exemplary embodiment.

FIG. 24 is a detailed front perspective view of the frame assembly of FIG. 21 with the footrest in the first position, according to an exemplary embodiment.

FIG. 25 is a cross-section view of the frame assembly of FIG. 3 in a lounge position with a footrest in a first position, according to an exemplary embodiment.

FIG. 26 is a front perspective view of the footrest of FIG. 25 in a second position, according to an exemplary embodiment.

FIG. 27 is a rear perspective view of a portion of the footrest of FIG. 25 in the second position, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As will be discussed in greater detail below, a 14-way adjustable front seat of the present disclosure provides enhanced adjustability to provide increased comfort to drivers and front passengers of a vehicle. Such a 14-way adjustable front seat may be particularly enjoyed by operators who drive a car for a living (e.g., taxi drivers, ride share drivers, limousine drivers, delivery drivers, etc.), electric vehicle operators, etc. where such operators may have time to wait between driving events (e.g., while waiting for a passenger, while waiting for the vehicle to charge at a charging station, to sleep or nap along a long-distance route, etc.). Such a 14-way adjustable front seat may increase the wakefulness, efficiency, and comfort of the operator of the vehicle.

In some aspects of the present disclosure, a modular kit may be provided for converting a non-14-way adjustable seat into the 14-way adjustable seat. Advantageously, such a modular kit may provide the positional adjustments of the 14-way adjustable seat without requiring the purchasing of a replacement of the non-14-way adjustable vehicle seat. The modular kit may include adjustment modules and/or footrests that are configured to couple to the existing non-14-way adjustable seat.

### Vehicle and Passenger Cabin

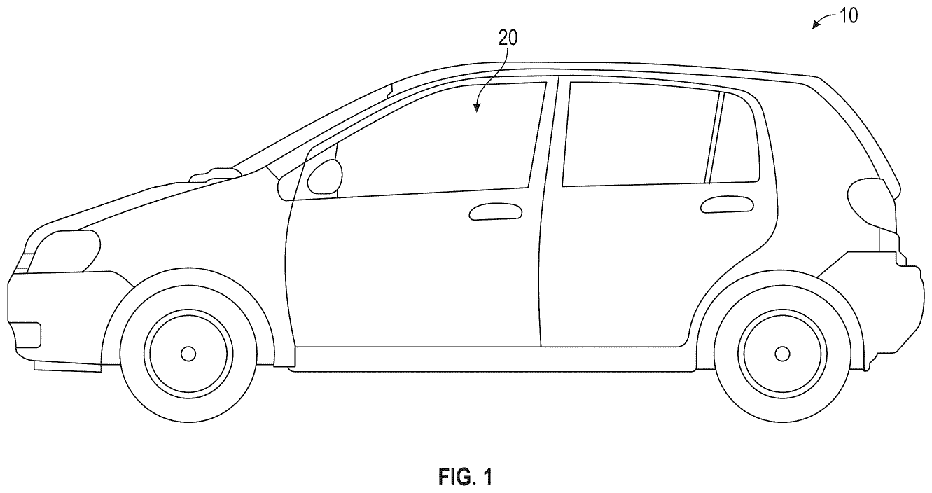

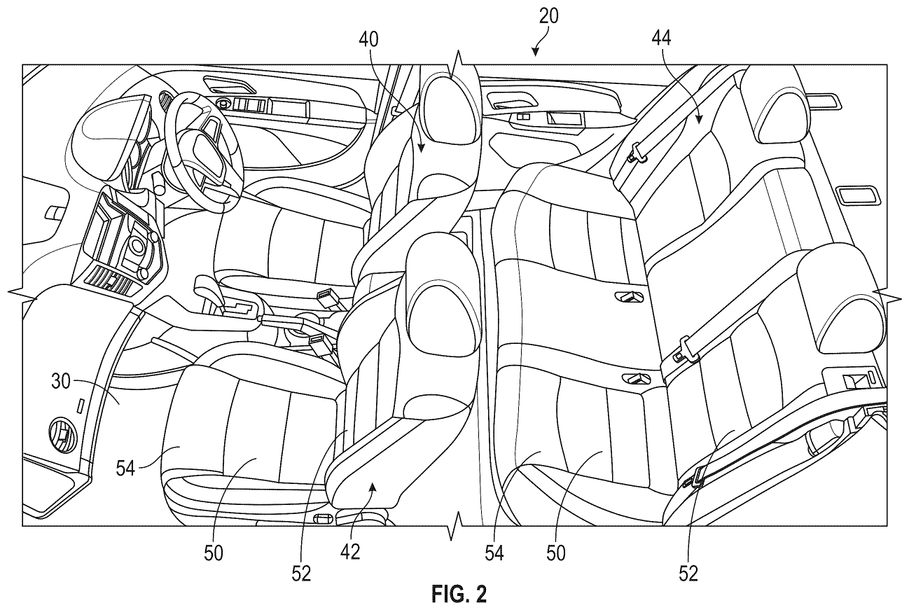

As shown in FIGS. 1 and 2, a vehicle 10 includes an interior cabin, shown as passenger cabin 20. In one embodiment, the vehicle 10 is configured as an on-road vehicle such as a sedan, a sport utility vehicle (“SUV”), a pickup truck, a van, or still another type of passenger vehicle. In other embodiments, the vehicle 10 is configured as another type of on-road vehicle such as a semi-truck, a bus, or the like. In still other embodiments, the vehicle 10 is configured as an off-road vehicle such as construction machinery, farming machinery, or the like.

As shown in FIG. 2, the passenger cabin 20 includes a support surface, shown as cabin floor 30, that supports one or more seating assemblies, shown as seats 40, including one or more first seating assemblies, shown as front seats 42, and one or more second seating assemblies, shown as rear seats 44. In some embodiments, the front seats 42 are different than the rear seats 44. In other embodiments, the front seats 42 and the rear seats 44 are the same or utilize similar components (e.g., to facilitate increased scaling for manufacturing and, therefore, a reduction in production costs). By way of example, the front seats 42 and the rear seats 44 may utilize a similar track assembly, however, the track assembly for one of the front seats 42 or the rear seats 44 may include one or more additional components (e.g., for added strength, to meet or exceed industry standards, etc.). In some embodiments, the passenger cabin 20 does not include the rear seats 44. In some embodiments, the passenger cabin 20 only includes a single front seat 42.

### Seat Assembly

As shown in FIGS. 2-4, each of the seats 40 includes a bottom cushion, shown as bottom seat cushion 50, configured to support a bottom (e.g., a buttocks, etc.) of an occupant (e.g., when the occupant is occupying the seat 40, etc.), a back cushion, shown as back seat cushion 52, configured to support a back (e.g., a dorsum, etc.) of the occupant, and a framing assembly (e.g., a skeleton, a frame, etc.), shown as frame assembly 100, configured to support the bottom seat cushion 50 and the back seat cushion 52. In some embodiments, the bottom seat cushion 50 includes a front cushion, shown as front cushion 54, supported by the frame assembly 100 and configured to support a thigh portion (e.g., a section of the body at the back of the thighs, etc.) of the occupant.

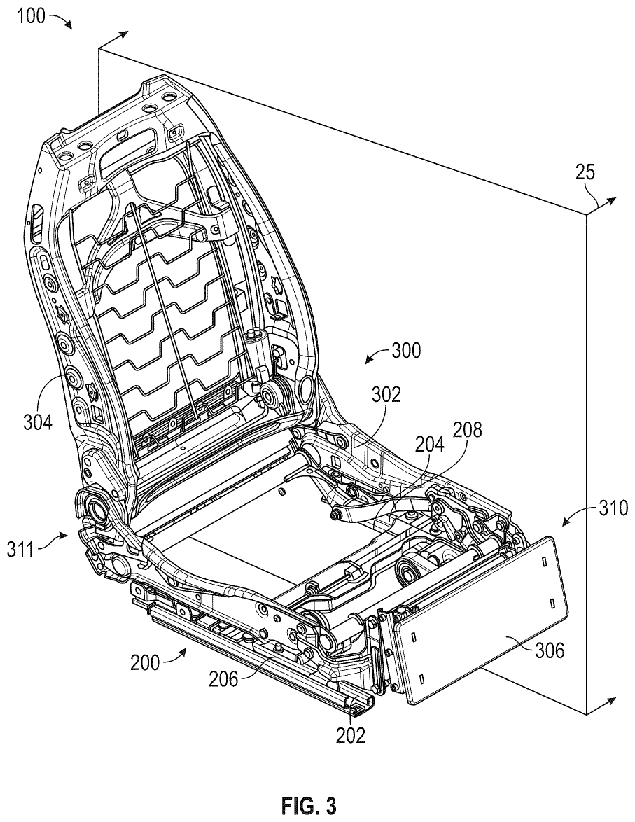

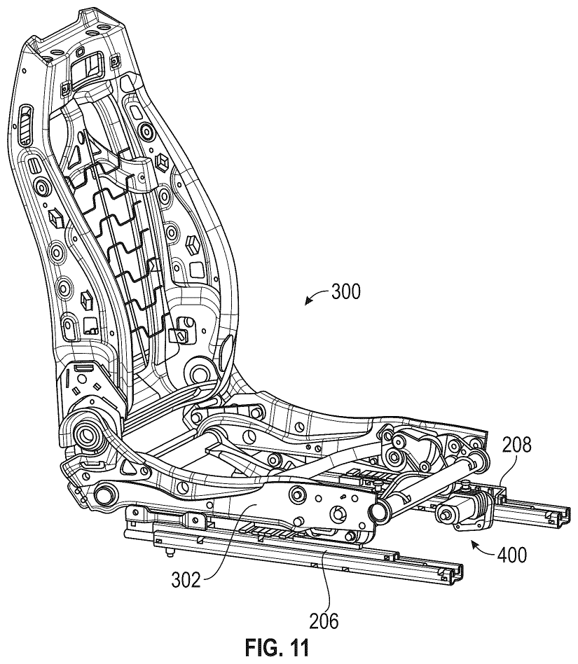

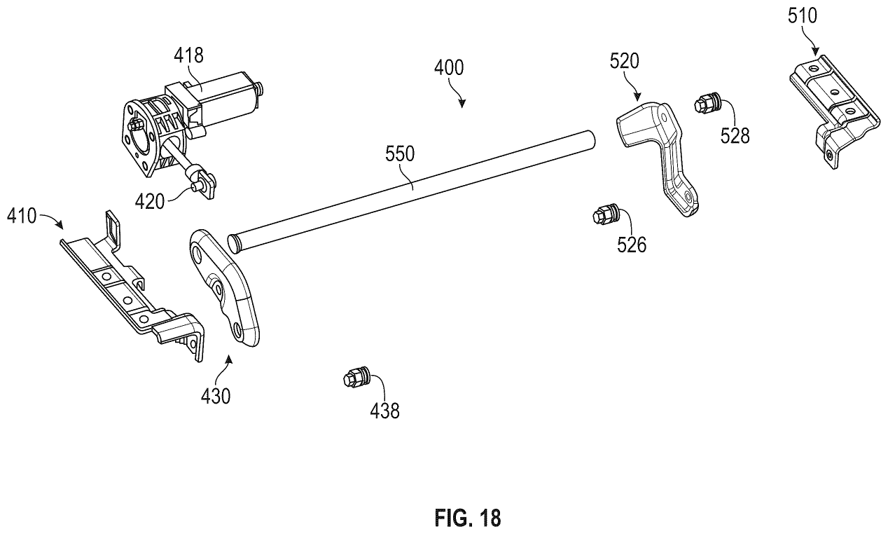

According to the exemplary embodiment shown in FIGS. 3-27, the seat 40 is configured as a 14-way adjustable seat (e.g., fore-aft seat translation adjustment, up-down seat adjustment, front thigh cushion up-down tilt, seat back fore-aft recline adjustment, and whole seat lounge adjustment with a constant or varying H-point center, footrest up-down adjustment, and footrest length adjustment). More specifically, the seat 40 may configured as a 14-way adjustable front seat. Such a 14-way adjustable front seat may provide enhanced comfort for a driver and/or a front seat passenger. Such a 14-way adjustable front seat may be particularly enjoyed by operators who drive a car for a living (e.g., taxi drivers, ride share drivers, limousine drivers, delivery drivers, etc.), electric vehicle operators, etc. where such operators may have time to wait between driving events (e.g., while waiting for a passenger, while waiting for the vehicle 10 to charge at a charging station, to sleep or nap along a long-distance route, etc.). Such a 14-way adjustable front seat may increase the wakefulness, efficiency, and comfort of the operator of the vehicle 10.

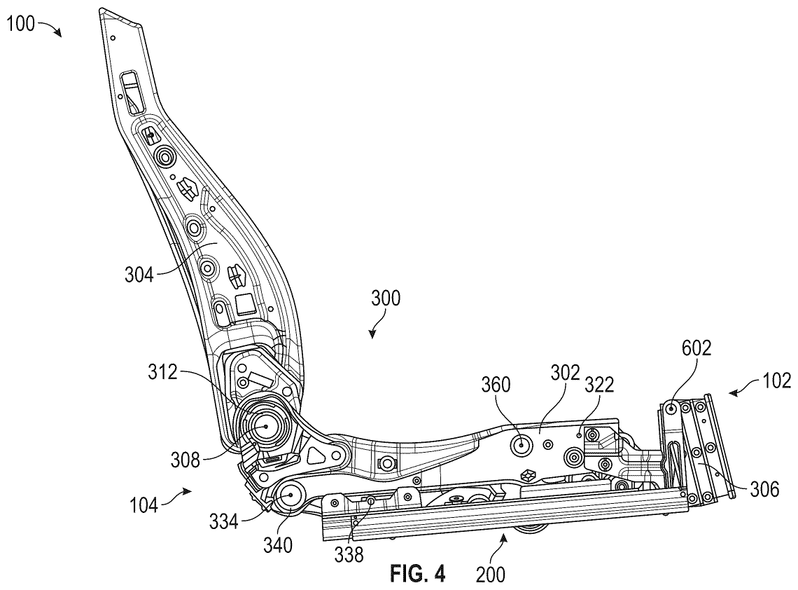

As shown in FIGS. 3 and 4, the frame assembly 100 includes: (i) a first frame portion, shown as track assembly 200 (e.g., slide assembly, etc.), configured to couple to the cabin floor 30, and (ii) a second frame portion, shown as seat frame assembly 300, coupled to the track assembly 200 and configured to support the bottom seat cushion 50 and the back seat cushion 52. As shown in FIG. 4, the frame assembly 100 includes a first end (e.g., a forward end, a front section, etc.), shown as front end 102, and an opposing second end (e.g., a rearward end, a front section, etc.), shown as rear end 104, positioned rearward of the front end 102 relative to the direction of travel of the vehicle 10.

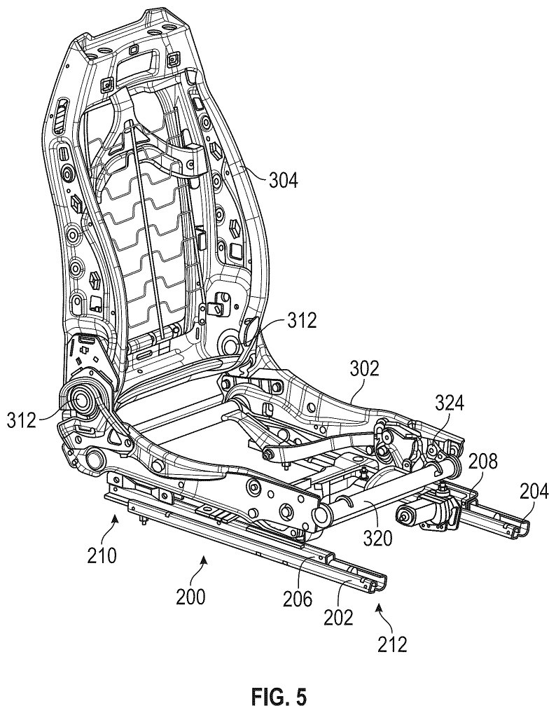

As shown in FIGS. 3, 5, 7, and 8, the track assembly 200 includes (i) a first track (e.g., a guide, a rail, etc.), shown as first base track 202, configured to couple to the cabin floor 30, (ii) a second track, shown as second base track 204, configured to couple to the cabin floor 30 and spaced from and positioned substantially parallel to the first base track 202, (iii) a third track (e.g., a carriage, a slider, etc.), shown as first slidable track 206, slidably coupled to the first base track 202 and configured to slide along a length of the first base track 202, and (iv) a fourth track, shown as second slidable track 208, slidably coupled to the second base track 204 and configured to slide along a length of the second base track 204. In other embodiments, the track assembly includes a different number of base track and slidable track pairs (e.g., one, three, four, etc.). In other embodiments, the track assembly 200 is a different translating mechanism (e.g., a rack and pinion system, a linear actuator, etc.). As shown in FIG. 5, the track assembly 200 includes a front, shown as track assembly front end 210, and a rear, shown as track assembly rear end 212, positioned rearward of the track assembly front end 210 relative to the direction of travel of the vehicle 10. According to an exemplary embodiment, the track assembly 200 is driven by a motor, a linkage assembly, a gearing mechanism, etc. to facilitate assisted or manual adjustment (e.g., forward translation, rearward translation, etc.) of the fore-aft position of the seat frame assembly 300, as described in greater detail herein.

As shown in FIGS. 3-6, the seat frame assembly 300 includes (i) a first frame portion, shown as seat frame 302, coupled to the first slidable track 206 and the second slidable track 208 and configured to support the bottom seat cushion 50, (ii) a second frame portion, shown as back frame 304, pivotably coupled to a first end, shown as rear end 311, of the seat frame 302 along a first axis (e.g., pivot, hinge, turning point, etc.), shown as recline axis 308, and configured to support the back seat cushion 52, and (iii) a third frame portion, shown as footrest 306, movably (e.g., pivotably, translatably, slidably etc.) coupled to an opposing second end, shown as front end 310, the seat frame 302 and configured to support the legs of the occupant. According to the exemplary embodiment shown in FIGS. 3-6, the seat frame 302 and the back frame 304 are pivotably coupled about the recline axis 308 by a first pair of couplers (e.g., pins, bolts, shafts, etc.), shown as back frame pins 312, each extending through an aperture in the seat frame 302 and an aperture in the back frame 304. In other embodiments, the seat frame 302 and the back frame 304 are rotatably coupled about the recline axis 308 by another pivoting mechanism (e.g., a four-bar linkage, a gear set, etc.). According to an exemplary embodiment, back frame 304 is driven by a motor, a linkage assembly, a gearing mechanism, etc. to facilitate assisted or manual adjustment (e.g., lowering, raising, etc.) of the fore-aft recline position of the back frame 304 relative to the seat frame 302, as described in greater detail herein.

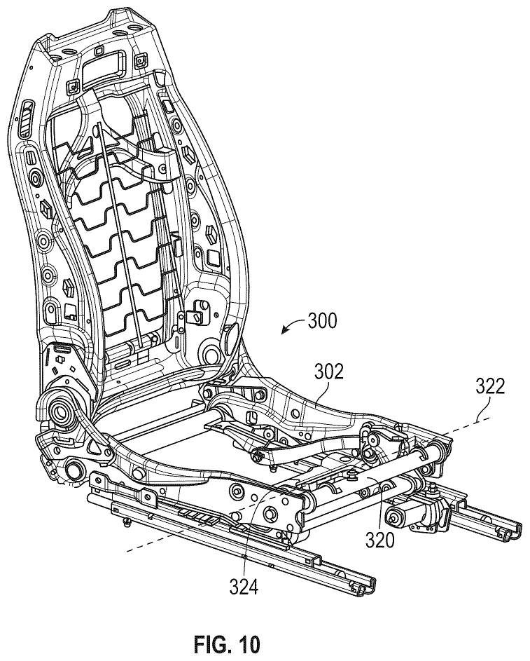

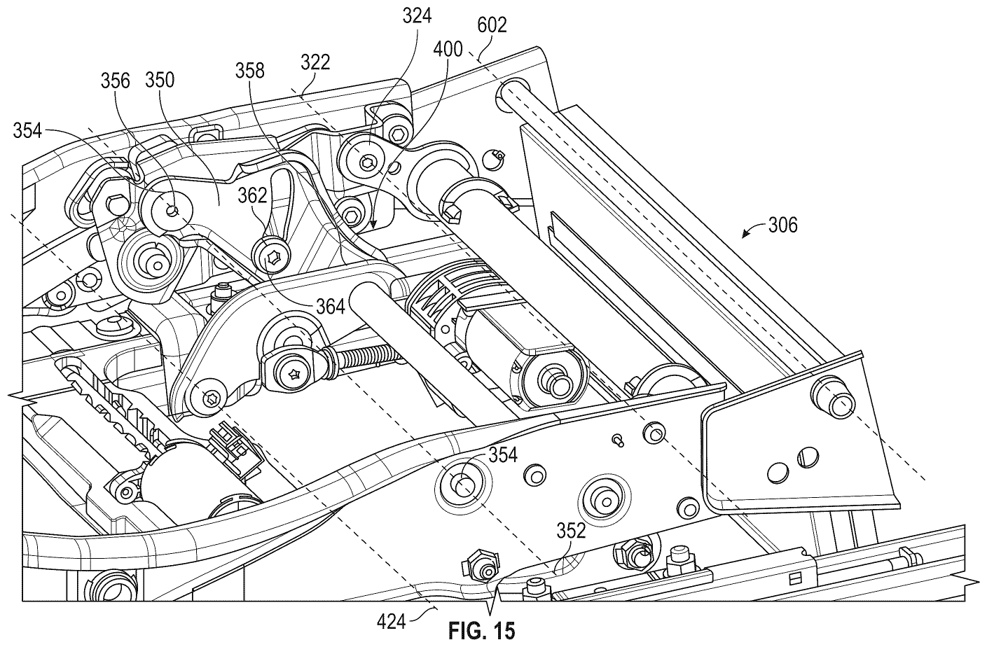

As shown in FIGS. 5 and 10, the seat frame 302 includes a thigh adjuster or adjustment mechanism (e.g., a beam, a mechanism, etc.), shown as thigh bar 320, movably (e.g., rotatably, pivotably, etc.) coupled to the seat frame 302. As shown in FIGS. 10 and 15, the thigh bar 320 is rotatably coupled to the seat frame 302 about a second axis, shown as thigh bar axis 322, by a third pair of couplers, shown as thigh bar pins 324, extending through apertures in the seat frame 302. In other embodiments, the thigh bar 320 is rotatably coupled to the seat frame 302 about the thigh bar axis 322 by an alternate rotatable mechanism. In still other embodiments, the thigh bar 320 is movably coupled to the seat frame 302 by a different mechanism (e.g., a linear actuator, a four-bar linkage, etc.). According to an exemplary embodiment, the thigh bar 320 is driven by a motor, a linkage assembly, a gearing mechanism, etc. to facilitate assisted or manual adjustment (e.g., lowering, raising, extending, retracting, etc.) of the position of the front cushion 54, as described in greater detail herein.

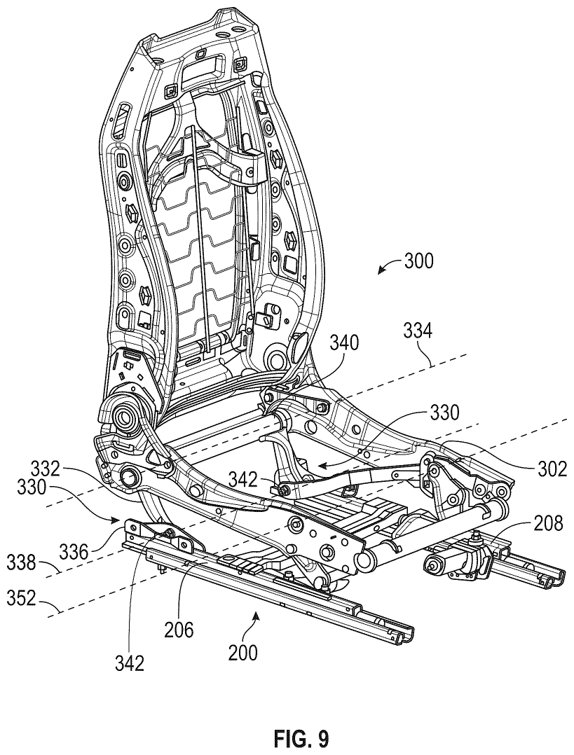

As shown in FIG. 9, the seat frame assembly 300 includes a first adjustment module (e.g., a first adjustment assembly, a first adjustment mechanism, etc.), shown as rear adjustment module 330, movably (e.g., rotatably, pivotably, etc.) coupled between (i) the seat frame 302 and (ii) the first slidable track 206 and the second slidable track 208 proximate the rear end 104 of the frame assembly 100.

As shown in FIG. 9, the rear adjustment module 330 includes (i) a pair of linkages (e.g., connectors, struts, arms, etc.), shown as rear linkages 332, and (ii) a pair of mounting brackets, shown as rear linkage mounting brackets 336. The rear linkages 332 extend between (i) a first axle (e.g., a first shaft, a first rod, etc.), shown as rear module axle 340, extending laterally across and through apertures defined by the seat frame 302 at the rear end 104 of the frame assembly 100 and (ii) the rear linkage mounting brackets 336. The rear linkage mounting brackets 336 are coupled to the first slidable track 206 and the second slidable track 208 proximate the rear end 104 of the frame assembly 100. Each of the rear linkages 332 is pivotably coupled to the rear module axle 340 (e.g., the rear module axle 340 extends through an aperture of each of the rear linkages 332) such that first or upper ends of the rear linkages 332 pivot about a third axis, shown as rear linkage axis 334, defined by the rear module axle 340. Each of the rear linkages 332 is pivotably coupled to one of rear linkage mounting brackets 336 by a fourth pair of couplers, shown as rear bracket pins 342, extending through corresponding apertures thereof such that second or lower ends of the rear linkages 332 pivot about a fourth axis, shown as rear mounting bracket axis 338, defined by the rear bracket pins 342. According to an exemplary embodiment, the rear adjustment module 330 is driven by a motor, a linkage assembly, a gearing mechanism, etc. to facilitate assisted or manual adjustment (e.g., lowering, raising, extending, retracting, etc.) of the rear end 104 of the seat frame 302 relative to the track assembly 200, as described in greater detail herein.

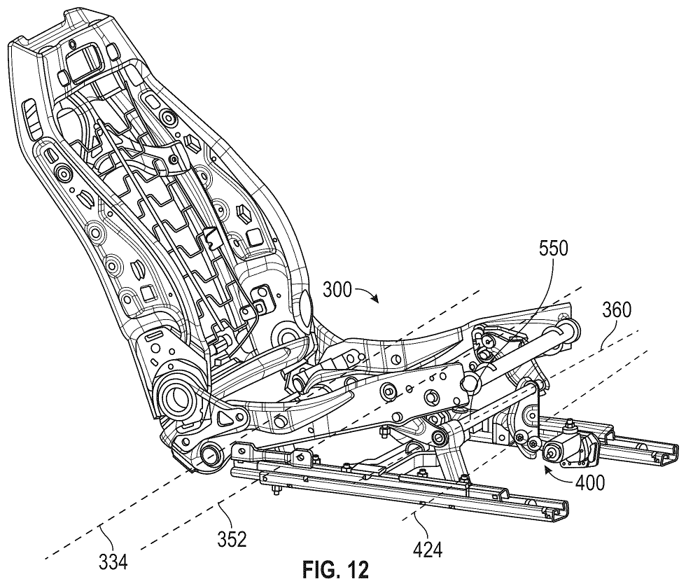

As shown in FIGS. 12-20, the seat frame assembly 300 includes a second adjustment module (e.g., a second adjustment assembly, a second adjustment mechanism, etc.), shown as front adjustment module 400. The front adjustment module 400 is movably (e.g., rotatably, pivotably, etc.) coupled to (i) the seat frame 302 and (ii) the first slidable track 206 and the second slidable track 208 proximate the front end 102 of the frame assembly 100.

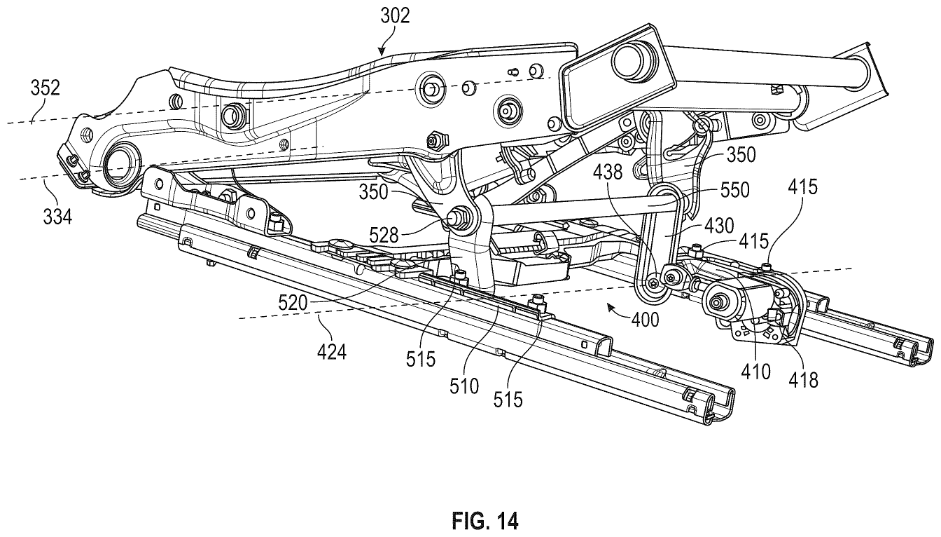

As shown in FIGS. 14-20, the front adjustment module 400 includes (i) a first bracket (e.g., a coupler, a mount, etc.), shown as first mounting bracket 410, coupled to the front end 102 of the second slidable track 208, (ii) a first linkage, shown as first lower linkage 430, pivotably coupled to the first mounting bracket 410, (iii) a second bracket, shown as second mounting bracket 510, coupled to the front end 102 of the first slidable track 206, (iv) a second linkage, shown as second lower linkage 520, rotatable coupled to the second mounting bracket 510, and (v) a first pair of brackets (e.g., a third bracket, a fourth bracket, etc.), shown as front adjustment brackets 350, each pivotably coupled to one of the first lower linkage 430 or the second lower linkage 520 along a fifth axis, shown as the front adjustment module axis 360, and pivotably coupled to the seat frame 302 along a sixth axis, shown as front adjustment bracket axis 352. In other embodiments, the front adjustment module 400 includes one of (i) the first mounting bracket 410, the first lower linkage 430, and one of the front adjustment brackets 350 pivotably coupled to the first lower linkages 430 or (ii) the second mounting bracket 510, the second lower linkage 520, and one of the front adjustment brackets 350 pivotably coupled to the second lower linkage 520.

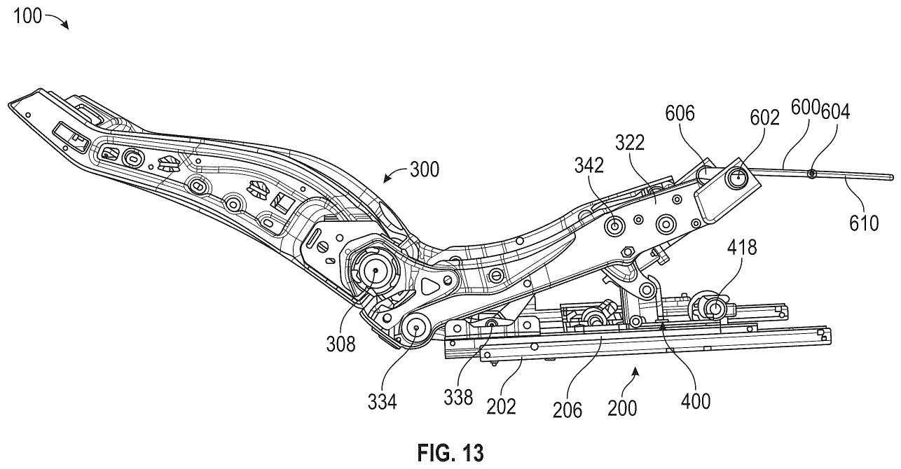

As shown in FIGS. 13-15 and 17-19, the front adjustment module 400 includes an actuator (e.g., a piston, a motor, etc.), shown as electric motor 418, configured to drive (e.g., move, pivot, etc.) the other components of the front adjustment module 400. In some embodiments, the front adjustment module 400 includes more than one of the electric motor 418 (e.g., two motors, three motors, etc.). In other embodiments, the front adjustment module 400 does not include the electric motor 418 (e.g., when the front adjustment module 400 is manually manipulated, etc.).

As shown in FIGS. 14 and 17-20, the front adjustment module 400 includes a cross axle (e.g., a cross rod, a cross shaft, etc.), shown as crossbar 550, coupled to and extending between the first lower linkage 430 (e.g., at the second pivot aperture 432) and the second lower linkage 520 (e.g., at the sixth pivot aperture 524). According to an exemplary embodiment, the crossbar 550 is configured to ensure that the first lower linkage 430 and the second lower linkage 520 pivot together. In other embodiments, the front adjustment module 400 does not include the crossbar 550. In such embodiments, the front adjustment module 400 may include two electric motors 418 (e.g., a first electric motor coupled to the first lower linkage 430 and a second electric motor coupled to the second lower linkage 520).

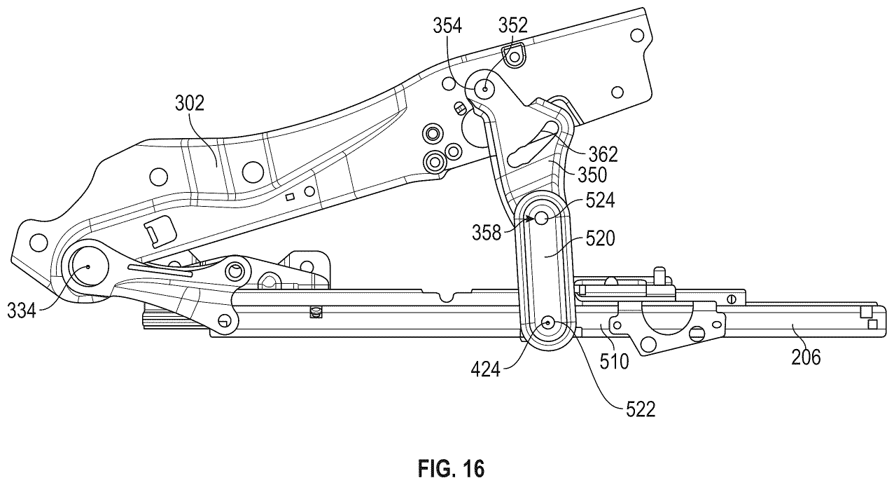

As shown in FIGS. 15 and 16, each of the front adjustment brackets 350 defines a first aperture (e.g., a hole, a slot, etc.), shown as seat aperture 354, positioned proximate a first end of the front adjustment bracket 350. As shown in FIG. 15, the front adjustment brackets 350 are pivotably coupled to the seat frame 302 about the front adjustment bracket axis 352 by a fifth pair of couplers, shown as front bracket couplers 356, that extend through the seat apertures 354 of the front adjustment brackets 350 and corresponding apertures defined by the seat frame 302. As shown in FIGS. 15 and 16, each of the front adjustment brackets 350 define a second aperture, shown as lower linkage aperture 358, positioned proximate a second end of the front adjustment bracket 350 opposite the first end.

As shown in FIGS. 15 and 16, each of the front adjustment brackets 350 defines a third aperture, shown as pivot slot 362. As shown in FIG. 15, each of the pivot slots 362 is configured to align with and receive a pin, shown as guide pin 364, coupled to the seat frame 302 to partially constrain movement of the front adjustment brackets 350 about front adjustment bracket axis 352 and relative to the seat frame 302, and guide the movement thereof. In other embodiments, the front adjustment brackets 350 do not define the pivot slots 362 and may fully rotate about the front adjustment bracket axis 352.

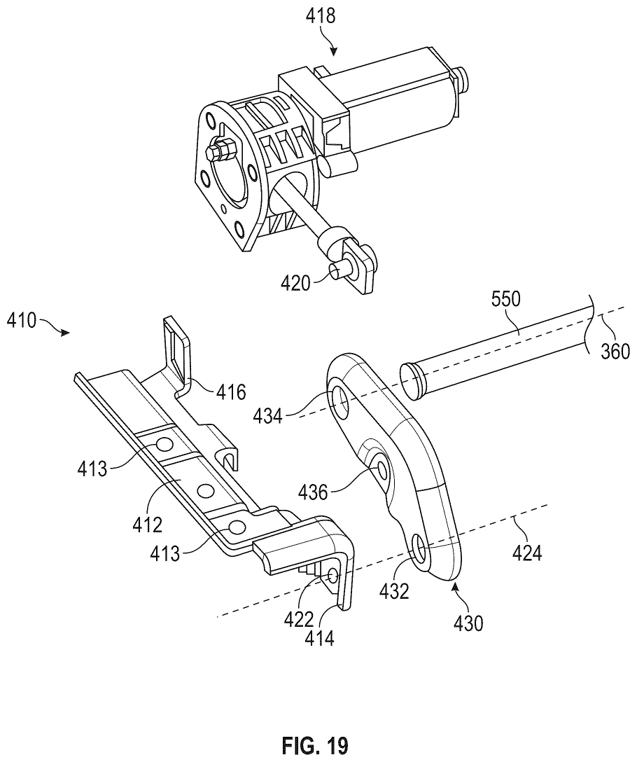

As shown in FIG. 19, the first mounting bracket 410 has (i) a first portion, shown as first mounting body 412, (ii) a second portion, shown as first pivot flange 414, extending perpendicular and downward from a first end (e.g., a rear end) of the first mounting body 412, and (iii) a third portion, shown as actuator mounting flange 416, extending perpendicular and upward from an opposing second end (e.g., a front end) of the first mounting body 412.

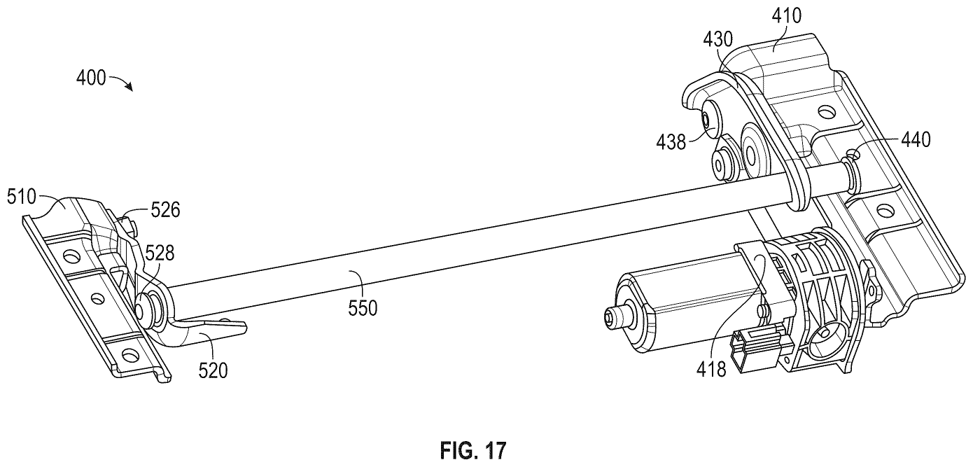

As shown in FIG. 19, the first mounting bracket 410 defines a first plurality of apertures, shown as first mounting apertures 413, spaced along the length of the first mounting body 412. According to the exemplary embodiment shown in FIG. 14, the first mounting apertures 413 align with apertures defined by the second slidable track 208 to cooperatively receive a first plurality of couplers, shown as first mounting fasteners 415. In other embodiments, the first mounting bracket 410 and the second slidable track 208 are integrally formed (e.g., form a single weldment, welded, a single cast or forged component, etc.). As shown in FIG. 19, the first pivot flange 414 defines an aperture, shown as first pivot aperture 422. According to an exemplary embodiment, the actuator mounting flange 416 is configured to engage with and facilitate coupling the electric motor 418 to the first mounting bracket 410 (see, e.g., FIG. 17). As shown in FIG. 19, the electric motor 418 includes an actuator end, shown as actuator arm 420, configured to extend and contract from the electric motor 418. In other embodiments, the first mounting bracket 410 does not include the actuator mounting flange 416 (e.g., if the front adjustment module 400 is manually actuated, etc.).

As shown in FIG. 19, the first lower linkage 430 defines (i) a first aperture (e.g., a hole, a slot, etc.), shown as second pivot aperture 432, proximate a first end of the first lower linkage 430, (ii) a second aperture, shown as third pivot aperture 434, proximate a second end of the first lower linkage 430 opposite the first end, and (iii) a third aperture, shown as actuator aperture 436, positioned between the second pivot aperture 432 and the third pivot aperture 434. The second pivot aperture 432 of the first lower linkage 430 aligns with the first pivot aperture 422 of the first mounting bracket 410 along a seventh axis, shown as front mounting bracket axis 424. According to the exemplary embodiment shown in FIGS. 14 and 15, the second pivot aperture 432 and the first pivot aperture 422 align to selectively receive a first coupler (e.g., pins, shafts, mandrels, connectors, non-bolt couplers or connectors, non-threaded couplers or connectors, etc.), shown as first pivot pin 438. In other words, the first pivot pin 438 is used to pivotably couple the first lower linkage 430 to the first mounting bracket 410. According to the exemplary embodiment shown in FIGS. 14, 15, 17, and 19, the third pivot aperture 434 of the first lower linkage 430 and the lower linkage aperture 358 of one of the front adjustment brackets 350 align along the front adjustment module axis 360 to selectively receive or engage with the crossbar 550, which is retained in position by a second coupler, shown as first end cap fastener 440. In other words, the crossbar 550 and the first end cap fastener 440 are used to pivotably couple the first lower linkage 430 to one of the front adjustment brackets 350. According to the exemplary embodiment, the actuator arm 420 of the electric motor 418 is configured to pivotably couple to the actuator aperture 436 of the first lower linkage 430 (see, e.g., FIGS. 15 and 17).

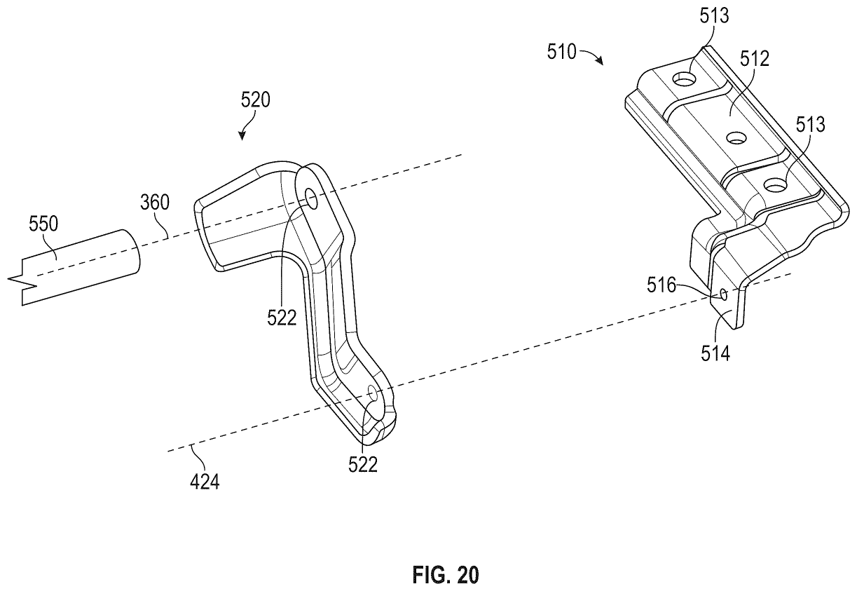

As shown in FIGS. 20, the second mounting bracket 510 has (i) a first portion, shown as second mounting body 512, and (ii) a second portion, shown as second pivot flange 514, extending perpendicular and downward from a first end (e.g., rear end) of the second mounting body 512. According to the exemplary embodiment shown herein, the second mounting bracket 510 is different than the first mounting bracket 410 (i.e., does not define an actuator mounting flange similar to the actuator mounting flange 416 of the first mounting bracket 410). In other embodiments, however, the second mounting bracket 510 is similar to or the same as the first mounting bracket 410 such that the second mounting bracket 510 has a flange similar to or the same as the actuator mounting flange 416 extending from a second end (e.g., front end) of the second mounting body 512 (e.g., when the front adjustment module 400 includes a second electric motor 418, etc.).

As shown in FIG. 20, the second mounting bracket 510 defines a plurality of apertures (e.g., holes, slots, etc.), shown as second mounting apertures 513, spaced along the length of the second mounting body 512. According to the exemplary embodiment shown in FIG. 14, the second mounting apertures 513 align with apertures defined by the first slidable track 206 to cooperatively receive a second plurality of couplers, shown as second mounting fasteners 515. In other embodiments, the second mounting bracket 510 and the first slidable track 206 are integrally formed. As shown in FIG. 20, the second pivot flange 514 defines an aperture, shown as fourth pivot aperture 516.

As shown in FIG. 20, the second lower linkage 520 defines (i) a fifth aperture (e.g., a hole, a slot, etc.), shown as fifth pivot aperture 522, proximate a first end of the second lower linkage 520, and (ii) a sixth aperture, shown as sixth pivot aperture 524, proximate a second end of the second lower linkage 520 opposite the first end. The sixth pivot aperture 524 of the second lower linkage 520 aligns with the fourth pivot aperture 516 of the second mounting bracket 510 along the front mounting bracket axis 424. According to the exemplary embodiment shown in FIG. 14, the sixth pivot aperture 524 and the fourth pivot aperture 516 align to selectively receive a first coupler (e.g., pins, shafts, mandrels, connectors, non-bolt couplers or connectors, non-threaded couplers or connectors, etc.), shown as second pivot pin 526. In other words, the second pivot pin 526 is used to pivotably couple the second lower linkage 520 to the second mounting bracket 510. According to the exemplary embodiment shown in FIGS. 14, 17, and 20, the sixth pivot aperture 524 of the second lower linkage 520 and the lower linkage aperture 358 of one of the front adjustment brackets 350 align along the front adjustment module axis 360 to selectively receive or engage with the crossbar 550, which is retained in position by a second coupler, shown as second end cap fastener 528. In other words. the crossbar 550 and the second end cap fastener 528 are used to pivotably couple the second lower linkage 520 to one of the front adjustment brackets 350.

According to the exemplary embodiment shown in FIGS. 13 and 21-24, the footrest 306 includes (i) a first or base portion, shown as footrest base 600, pivotably coupled to the seat frame 302 about an eighth axis, shown as footrest axis 602, and (ii) a second or extension portion, shown as footrest extension 610, coupled (e.g., pivotably, translationally, etc.) to the footrest base 600. In other embodiments, the footrest base 600 linearly translates toward and away from the seat frame 302. In still other embodiments, the footrest base 600 extends from and retracts toward the seat frame 302 in a method different than rotation or linear translation (e.g., the footrest base 600 may swing on a linkage to extend and retract relative to the seat frame 302, etc.). According to an exemplary embodiment, the footrest base 600 is configured to support a first, upper portion of the legs (e.g., knee area, upper calf area, etc.) of the occupant. As shown in FIG. 4, the footrest axis 602 is located forward of the thigh bar axis 322. In some embodiments, the footrest 306 does not include the footrest extension 610.

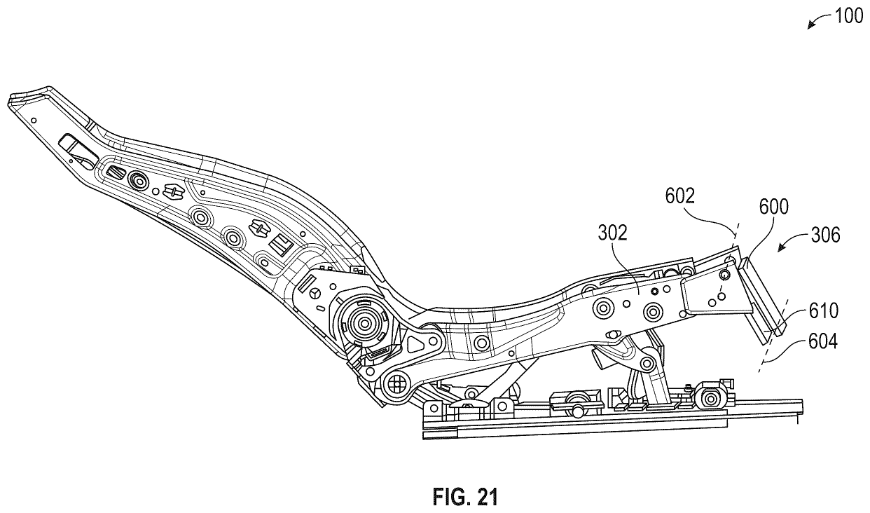

According to the exemplary embodiment shown in FIGS. 21-23, the footrest extension 610 is pivotably coupled to the footrest base 600 and pivots relative to the footrest base 600 about a ninth axis, shown as footrest extension axis 604. In other embodiments, the footrest extension 610 is translationally coupled to the footrest base 600 and linearly extends and retract relative to the footrest base 600. In still other embodiments, the footrest extension 610 extends from and retracts toward the footrest base 600 in a method different than rotation or linear translation (e.g., the footrest extension 610 may swing on a linkage to extend and retract relative to the footrest base 600, etc.). According to an exemplary embodiment, the footrest extension 610 is configured to support a second, lower portion of the legs (e.g., lower calf area, feet, etc.) of the occupant.

According to the exemplary embodiment shown in FIGS. 21-24, the footrest base 600 is configured as a plate-like component extending across a width of the frame assembly 100. In other embodiments, the footrest base 600 is different or has a different shape (e.g., two plates orientated parallel to each other, a plate with apertures to allow airflow through the footrest base 600 and reduce the weight of the footrest base 600, a contoured plate that defines leg recess or dimples, etc.).

According to the exemplary embodiment shown in FIGS. 21-24, the footrest extension 610 is configured as a plate-like component extending across the width of the frame assembly 100. In other embodiments, the footrest extension 610 is different or has a different shape (e.g., two plates orientated parallel to each other, a plate with apertures to allow airflow through the footrest extension 610 and reduce the weight of the footrest extension 610, a contoured plate that defines leg recess or dimples, etc.).

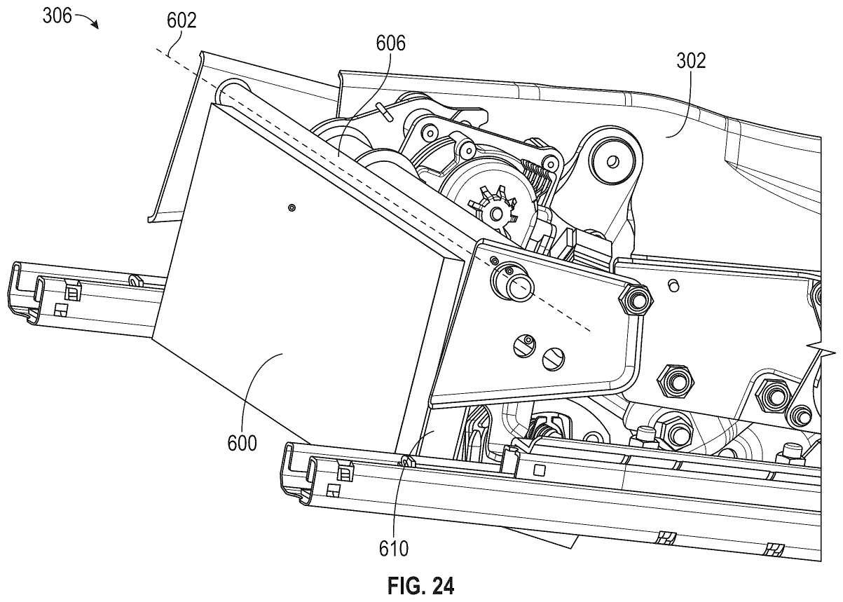

According to the exemplary embodiment shown in FIGS. 13 and 24, the footrest base 600 of the footrest 306 is pivotably coupled to the seat frame about the footrest axis 602 by a second axle (e.g., a second rod, a second shaft, etc.), shown as footrest axle 606, extending through apertures in the seat frame 302 and coupled to the footrest base 600. In other embodiments, the seat frame 302 and the footrest 306 are rotatably coupled about the footrest axis 602 by another rotatable mechanism.

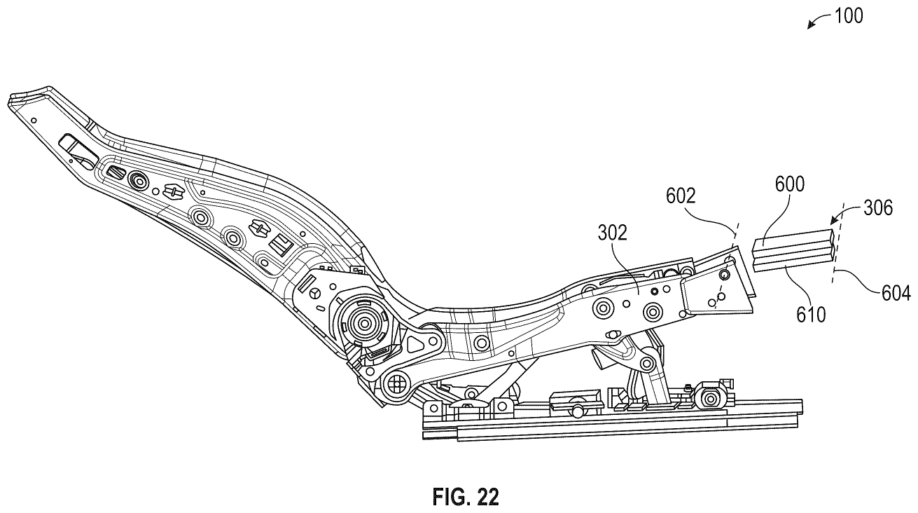

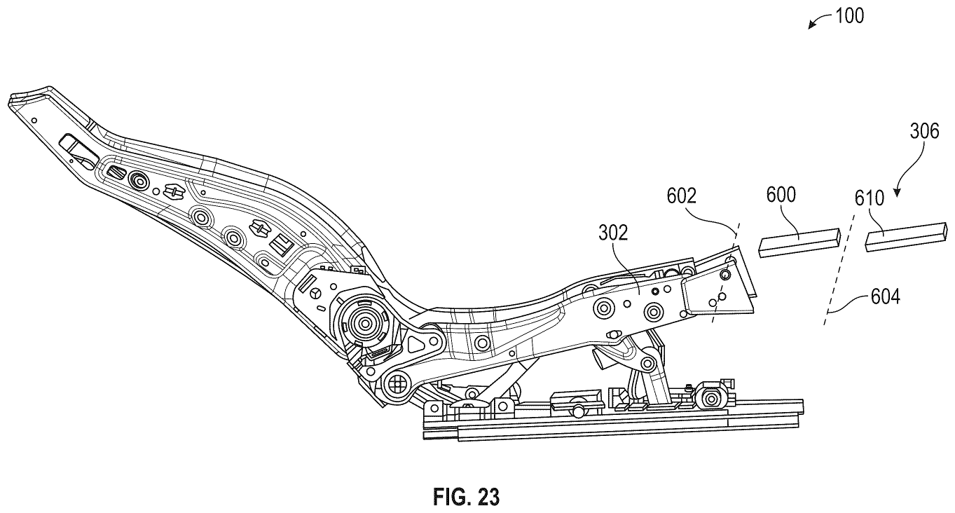

In some embodiments, the footrest 306 includes one or more independent footrest motors that facilitate reconfiguring the footrest 306 between a stowed or retracted orientation (see, e.g., FIG. 21), a deployed orientation (see, e.g., FIG. 22), and an extended orientation (see, e.g., FIG. 23). In some embodiments, the footrest 306 is linked to the front adjustment module 400 and driven by the electric motor 418 thereof. In some embodiments, the footrest 306 is manually actuatable (e.g., via a lever and linkage mechanism).

According to the exemplary embodiment shown in FIGS. 4 and 25-27, the footrest 306 includes (i) a fifth bracket, shown as extension bracket 660, coupled to the crossbar 550, (ii) a second pair of brackets, shown as pivot brackets 670, coupled to the front end of the seat frame 302, (iii) an extension assembly (e.g., scissor linkage assembly, etc.), shown as linkage assembly 680, coupled to the extension bracket 660 and the pivot brackets 670, and (iv) a footrest base, shown as footrest support 700, coupled to the linkage assembly 680 and configured to support a portion of the legs of the occupant. In some embodiments, the extension bracket 660 is coupled to the crossbar 550 between the first lower linkage 430 and the second lower linkage 520.

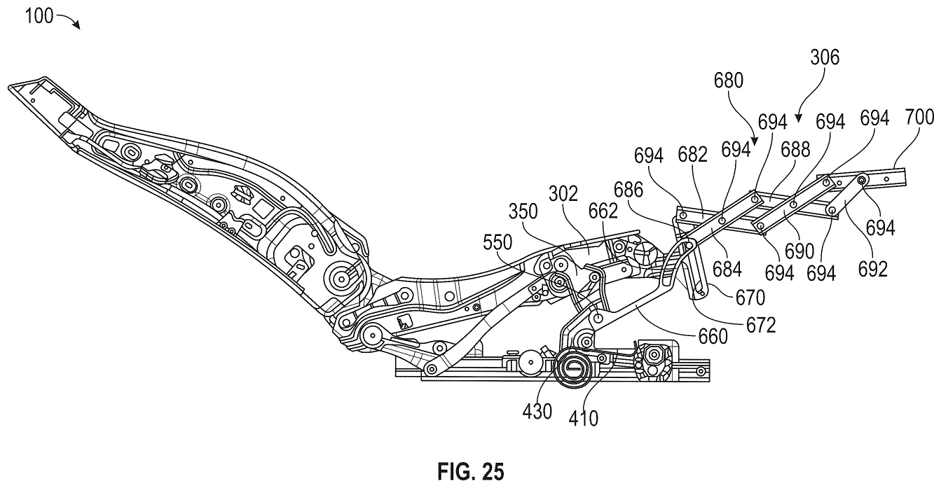

As shown in FIGS. 25-27, the linkage assembly 680 includes (i) a first pair of linkage members, shown as first linkages 682, pivotably coupled to the pivot brackets 670, (ii) a second pair of linkage members, shown as second linkages 684, pivotably coupled to the first linkages 682, (iii) a second bar, shown as linkage bar 686, coupled to the second linkages 684, slidably coupled to the extension bracket 660, and slidably coupled to the pivot brackets 670, (iv) a third pair of linkage members, shown as third linkages 688, pivotably coupled to the second linkages 684, (v) a fourth pair of linkage members, shown as fourth linkages 690, pivotably coupled to the first linkages 682, pivotably coupled to the third linkages 688, and pivotably coupled to the footrest support 700, and (vi) a fifth pair of linkage members, shown as fifth linkages 692, pivotably coupled to the third linkages 688 and pivotably coupled to the footrest support 700.

According to the exemplary embodiment shown in FIG. 25, the first linkages 682, the second linkages 684, the third linkages 688, and the fourth linkages 690 have a first length and the fifth linkages 692 have a second length that is different than the first length.

The first linkages 682 may be pivotably coupled to the pivot brackets 670 at proximal ends (e.g., first ends, etc.) of the first linkages 682, pivotably coupled to the fourth linkages 690 at distal ends (e.g., second opposing ends, etc.) of the first linkages 682, and pivotably coupled to the second linkages 684 at a location between the proximal ends of the first linkages 682 and the distal ends of the first linkages 682. The second linkages 684 may be coupled to the linkage bar 686 at proximal ends of the second linkages 684, pivotably coupled to the third linkages 688 at distal ends of the second linkages 684, and pivotably coupled to the first linkages 682 at a location between the proximal ends of the second linkages 684 and the distal ends of the second linkages 684. The third linkages 688 may be pivotably coupled to the second linkages 684 at proximal ends of the third linkages 688, pivotably coupled to the fifth linkages 692 at distal ends of the third linkages 688, and pivotably coupled to the fourth linkages 690 at a location between the proximal ends of the third linkages 688 and the distal ends of the third linkages 688. The fourth linkages 690 may be pivotably coupled to the first linkages 682 at proximal ends of the fourth linkages 690, pivotably coupled to the footrest support 700 at distal ends of the fourth linkages 690, and pivotably coupled to the third linkages 688 at a location between the proximal ends of the fourth linkages 690 and the distal ends of the fourth linkages 690. The fifth linkages 692 may be pivotably coupled to the third linkages 688 at proximal ends of the fifth linkages 692 and pivotably coupled to the footrest support 700 at distal ends of the fifth linkages 692.

As shown in FIGS. 25-27, the linkage assembly 680 includes a plurality of bars, shown as linkage axles 694, extending along pivot axis of the linkage assembly 680 (e.g., axis that components of the linkage assembly 680 pivot around, etc.) to pivotably couple the components of the linkage assembly 680 to each other, pivotably couple the components of the linkage assembly 680 to the pivot brackets 670, and/or pivotably couple the components of the linkage assembly 680 to the footrest support 700. As shown in FIGS. 25-27, a first of the linkage axles 694 extends through apertures in first linkages 682 and the pivot brackets 670 to pivotably couple the first linkages 682 to the pivot brackets 670, a second of the linkage axles 694 extends through apertures in the first linkages 682 and the second linkages 684 to pivotably couple the first linkages 682 and the second linkages 684, a third of the linkage axles 694 extends through apertures in the second linkages 684 and the third linkages 688 to pivotably coupled the second linkages 684 and the third linkages 688, a fourth of the linkage axles 694 extends through apertures in the first linkages 682 and the fourth linkages 690 to pivotably couple the first linkages 682 and the fourth linkages 690, a fifth of the linkage axles 694 extends through apertures in the third linkages 688 and the fourth linkages 690 to pivotably couple the third linkages 688 and the fourth linkages 690, a sixth of the linkage axles 694 extends through apertures in the third linkages 688 and the fifth linkages 692 to pivotably couple the third linkages 688 and the fifth linkages 692, a seventh of the linkage axles 694 extends through apertures in the fourth linkages 690 and the footrest support 700 to pivotably couple the fourth linkages 690 and the footrest support 700, and an eighth of the linkage axles 694 extends through apertures in the fifth linkages 692 and the footrest support 700 to pivotably couple the fifth linkages 692 and the footrest support 700.

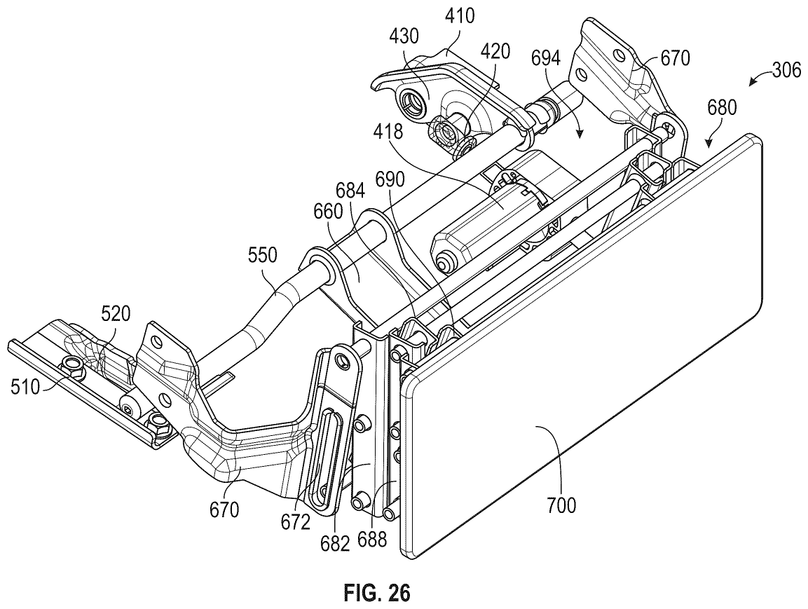

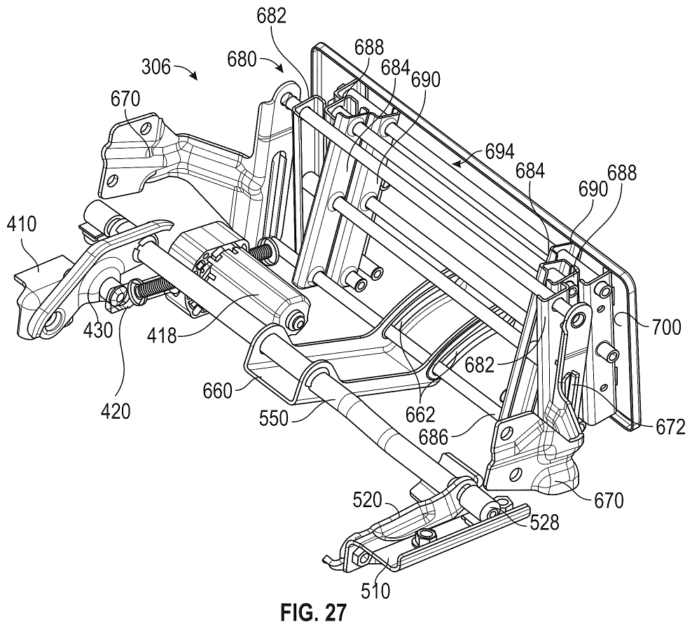

As shown in FIGS. 26 and 27, the linkage axles 694 extend between components on a first side (e.g., a left side, etc.) of the linkage assembly 680 and components on an opposing second side (e.g., a right side, etc.) of the linkage assembly 680 to ensure that the components on the first side of the linkage assembly 680 and the components on the second side of the linkage assembly 680 move together (e.g., move in synch, move at the same rate, move to corresponding positions, etc.). By way of example, one of the linkage axles 694 coupled between a first of the first linkages 682 and a second of the first linkages 682 may ensure that the first of the first linkages 682 and the second of the first linkages 682 move together. In other embodiments, the linkage assembly 680 includes a single of the linkage axles 694 extending along one of the pivot axles of the linkage assembly 680 to pivotably couple two of the components of the linkage assembly 680 to each other, pivotably couple the first linkages 682 to the pivot brackets 670, or pivotably couple the fourth linkages 690 or the fifth linkages 692 to the footrest support 700. In still other embodiments, the linkage assembly 680 does not include one or more of the linkage axles 694.

As shown in FIGS. 25 and 27, the extension bracket 660 defines a second plurality of apertures, guides, or slots, shown as extension apertures 662. As shown in FIGS. 25 and 27, the extension apertures 662 are configured to align with and receive the linkage bar 686 of the linkage assembly 680 to couple the second linkages 684 of the linkage assembly 680 to the extension bracket 660. By way of example, the extension apertures 662 may receive the linkage bar 686 of the linkage assembly 680 to guide the movement of the linkage assembly 680 relative to the extension bracket 660. As shown in FIGS. 25 and 27, the extension apertures 662 are configured as slots that align with and receive the linkage bar 686 of the linkage assembly 680 to slidably couple the extension bracket 660 to the linkage assembly 680 and guide the movement of the linkage bar 686 along the slot of the extension apertures 662. By way of example, when the first lower linkage 430 and the second lower linkage 520 are pivoted relative to the first mounting bracket 410 and the second mounting bracket 510, respectively, the resulting movement of the extension bracket 660 may guide the linkage bar 686 along the extension apertures 662 to guide the movement of the linkage assembly 680 relative to the extension bracket 660. In other embodiments, the extension apertures 662 are defined as circular holes configured to align with and receive the linkage bar 686 of the linkage assembly 680 to pivotably couple the linkage assembly 680 to the extension bracket 660. By way of example, when the first lower linkage 430 and the second lower linkage 520 are pivoted relative to the first mounting bracket 410 and the second mounting bracket 510, respectively, the resulting movement of the extension bracket 660 may move the linkage bar 686 with the extension bracket 660 to guide the movement of the linkage assembly 680 relative to the extension bracket 660. In still other embodiments, the extension bracket 660 defines a single one of the extension apertures 662.

As shown in FIGS. 25-27, each of the pivot brackets 670 define a seventh aperture, shown as pivot apertures 672. As shown in FIGS. 25-27, the pivot apertures 672 are configured to align with and receive the linkage bar 686 of the linkage assembly 680 to couple the second linkages 684 of the linkage assembly 680 to the pivot brackets 670. By way of example, the extension apertures 662 may receive the linkage bar 686 of the linkage assembly 680 to guide the movement of the linkage assembly 680 relative to the pivot brackets 670. As shown in FIGS. 25-27, the pivot apertures 672 are configured as slots that align with and receive the linkage bar 686 of the linkage assembly 680 to slidably couple the second linkages 684 of the linkage assembly 680 to the pivot brackets 670 and guide the movement of the linkage bar 686 along the slot of the pivot apertures 672. By way of example, when the movement of the extension bracket 660 moves the linkage bar 686 along the extension apertures 662, the linkage bar 686 may be moved along the pivot apertures 672 to guide the movement of the linkage assembly 680 relative to the pivot brackets 670.

As shown in FIGS. 26 and 27, the electric motor 418 is configured to drive (e.g., move, pivot, etc.) the components of the footrest 306. By way of example, the electric motor 418 may pivot the first lower linkage 430 relative to the first mounting bracket 410 to drive the components of the footrest 306. In other embodiments, the footrest 306 includes a footrest actuator (e.g., a piston, a motor, etc.) configured to drive (e.g., move, pivot, etc.) the other components of the footrest 306. By way of example, the footrest motor may be coupled to one of the pivot brackets 670 and configured to pivot the one of the pivot brackets 670 relative to the seat frame 302 to drive the other components of the footrest 306. In some embodiments, the footrest 306 includes more than one of the footrest motor. By way of example, the footrest 306 may include (a) a first footrest motor coupled to a first of the pivot brackets 670 and configured to pivot the first of the pivot brackets 670 relative to the seat frame 302 to drive the other components of the footrest 306 and (b) a second footrest motor coupled to a second of the pivot brackets 670 and configured to pivot the second of the pivot brackets 670 relative to the seat frame 302 to drive the other components of the footrest 306. In still other embodiments, the footrest 306 does not include the footrest motor (e.g., when the footrest 306 is manually manipulated, when the footrest 306 is driven by the electric motor 418, etc.).

According to the exemplary embodiment shown in FIGS. 25-27, the footrest support 700 is configured as a plate-like component extending across a width of the frame assembly 100. In other embodiments, the footrest support 700 is different or has a different shape (e.g., two plates orientated parallel to each other, a plate with apertures to allow airflow through the footrest support 700 and reduce the weight of the footrest support 700, a contoured plate that defines leg recess or dimples, etc.).

### Retrofit Solution

According to an exemplary embodiment, the front adjustment module 400 and the footrest 306 can be manufactured as a modular kit configured to provide a retrofit solution for converting an 8-way adjustable seat to a 14-way adjustable seat. Accordingly, various different front adjustment modules 400 and/or footrests 306 can be designed and manufactured to integrate into various different 8-way seats. Therefore, installing the front adjustment module 400 and/or the footrest 306 into an existing frame assembly of a seat may provide additional positional adjustment to the seat without requiring the purchase a new seat.

### Seat Operations

As described above, the seat 40 is configured as a 14-way adjustable seat that provides fore-aft seat translation adjustment, up-down seat adjustment, front thigh cushion up-down tilt, seat back fore-aft recline adjustment, and whole seat lounge movement to reconfigure the seat 40 from a base position or orientation to a comfort lounge position or orientation with a constant or varying H-point (hip-point) center, footrest up-down adjustment, and footrest length adjustment.

As shown in FIGS. 3-5 and 11, the seat frame assembly 300 can be moved, manipulated, reconfigured, etc. into a base orientation (e.g., neutral position, starting position, a nominal position, etc.) with (i) the back frame 304 in a standard, substantially vertical orientation relative the seat frame 302, (ii) the first slidable track 206 and the second slidable track 208 positioned substantially in the center of the first base track 202 and the second base track 204, respectively, (iii) the thigh bar 320 in a retracted, contracted, or stowed position such that the thigh bar 320 is not above a top surface of the seat frame 302 or providing any adjustment to the front cushion 54, and (iv) the rear adjustment module 330 and the front adjustment module 400 in a retracted, contracted, or stowed positions so that the seat frame 302 is substantially parallel to the cabin floor 30 or proximate or substantially flush with the track assembly 200. In some embodiments, the seat frame assembly 300 moves to the base orientation when an occupant activates or engages a user interface (e.g., presses a button, pulls a lever, taps a portion of a touch screen, etc.). In other embodiments, the occupant may manually move the seat frame assembly 300 to the base position (e.g., by applying forces to different components of the seat frame assembly 300, etc.).

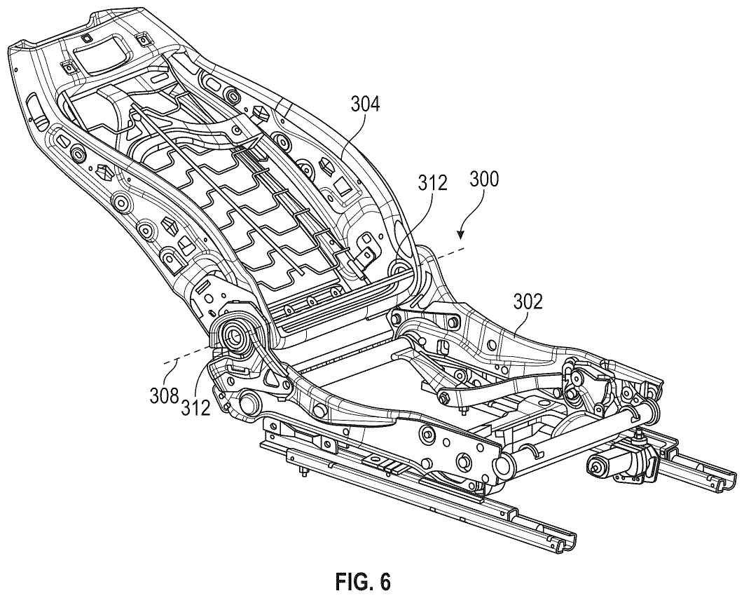

In operation, the back frame 304 facilitates providing fore-aft recline adjustment. For example, as shown in FIG. 6, the seat frame assembly 300 can be selectively reconfigurable into a reclined (e.g., leaned back, etc.) position by rotating the back frame 304 relative to the seat frame 302 about the recline axis 308 from the base position so that the back frame 304 is angled backward. The reclined position may allow the occupant to lean backwards at the waist while occupying the seat 40, which may be a more comfortable position for the occupant. In some embodiments, the back frame 304 may be rotated about the recline axis 308 manually (e.g., manually adjustable, by hand, etc.) by applying a force to the back frame 304. In some embodiments, the back frame 304 includes a lock (e.g., safety lock, rachet, etc.) that must be released prior to rotating the back frame 304. In other embodiments, the back frame 304 rotates about the recline axis 308 through the use of a motor (e.g., electronically adjustable, electromechanically adjustable etc.). In some embodiments, the back frame 304 rotates about the recline axis 308 when an occupant activates or engages a user interface (e.g., pressing a first button to rotate the back frame 304 in a first direction, pressing a second bottom to rotate the back frame 304 in a second direction, etc.). The rotation of the back frame 304 about the recline axis 308 may be defined or referred to as a first way of adjustment (e.g., the back frame 304 rotating forward about the recline axis 308 relative to the seat frame 302, etc.) and a second way of adjustment (e.g., the back frame 304 rotating backward about the recline axis 308 relative to the seat frame 302, etc.).

In some embodiments, the seat frame assembly 300 may also be configured in an acute (e.g., rotated forward, etc.) position by rotating the back frame 304 relative to the seat frame 302 about the recline axis 308 so that the back frame 304 is angled forward about the recline axis 308 relative to the base position. The vehicle 10 may only include a single pair of doors (e.g., access hatches, etc.), so the front seats 42 may be placed in the acute position to allow access to the rear seats 44 from the single pair of doors.

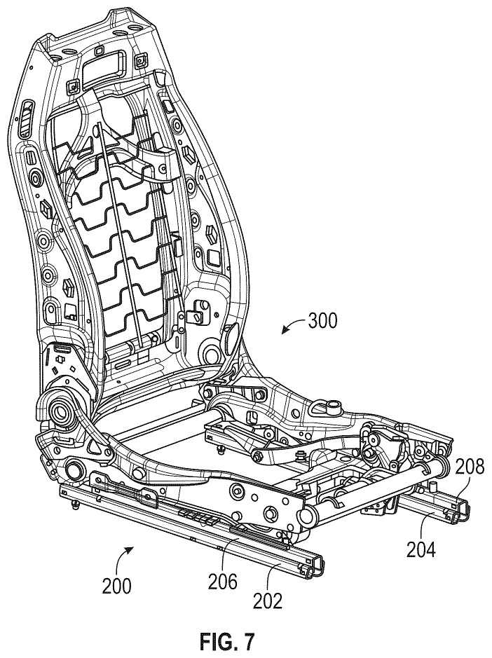

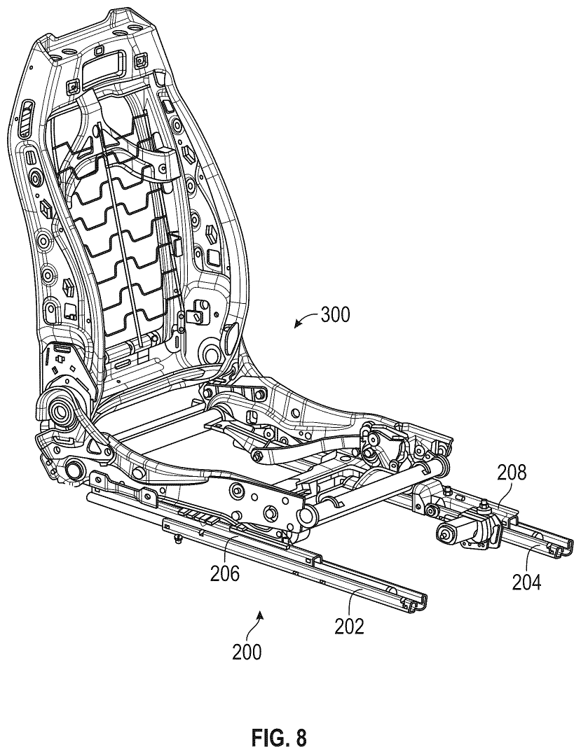

In operation, the track assembly 200 facilitates providing fore-aft seat translation adjustment. For example, as shown in FIG. 7, the seat frame assembly 300 can be selectively reconfigurable into a forward position by sliding the first slidable track 206 and the second slidable track 208 forward along the first base track 202 and the second base track 204, respectively, such that the seat frame assembly 300 is moved forward from the base position. The forward position may allow the occupant (e.g., a shorter occupant) to be closer to controls of the vehicle 10 (e.g., a steering wheel, a brake pedal, a gas petal, etc.). As another example, as shown in FIG. 8, the seat frame assembly 300 can be selectively reconfigurable into a rearward position by sliding the first slidable track 206 and the second slidable track 208 rearward along the first base track 202 and the second base track 204, respectively, such that the seat frame assembly 300 is moved rearward from the base position. The rearward position may allow for the occupant to have additional space available (e.g., more legroom, etc.), which may be a more comfortable position for the occupant (e.g., a taller occupant). In some embodiments, the first slidable track 206 and the second slidable track 208 are slidable along the first base track 202 and the second base track 204, respectively, through the use of a motor (e.g., electronically adjustable, electromechanically adjustable etc.). In some embodiments, the first slidable track 206 and the second slidable track 208 are slidable along the first base track 202 and the second base track 204, respectively, manually by applying a force to the seat frame assembly 300 in a forward or rearward direction (e.g., after engaging a release mechanism). In some embodiments, the first slidable track 206 and the second slidable track 208 are slidable along the first base track 202 and the second base track 204, respectively, after an occupant activates or engages a user interface (e.g., pressing a first button to slide the first slidable track 206 and the second slidable track 208 forward, pressing a second bottom to slide the first slidable track 206 and the second slidable track 208 rearward, engaging a release bar or mechanism, etc.). The sliding of the first slidable track 206 and the second slidable track 208 along the first base track 202 and the second base track 204, respectively, may be defined or referred to as a third way of adjustment (e.g., forward translation) and a fourth way of adjustment (e.g., rearward translation).

In operation, the rear adjustment module 330 facilitates providing up-down seat adjustment. For example, as shown in FIG. 9, the seat frame assembly 300 can be selectively reconfigurable into an up position by rotating the rear linkages 332 about the rear mounting bracket axis 338 such that the rear end 104 of the seat frame assembly 300 is lifted, causing the seat frame assembly 300 to pivot about the front adjustment bracket axis 352 so that the seat frame assembly 300 moves upward from the base position. The up position may allow the occupant to sit more comfortably or see out of the vehicle 10 better than from the base position. In some embodiments, the rear linkages 332 are rotated about the rear mounting bracket axis 338 by a driving rod and a motor. In some embodiments, the rear linkages 332 are rotated about the rear mounting bracket axis 338 after an occupant activates or engages a user interface (e.g., pressing a first button to rotate the rear linkages 332 to lift the seat frame assembly 300, pressing a second bottom to rotate the rear linkages 332 to lower the seat frame assembly 300, etc.). In other embodiments, the rear linkages 332 are rotated about the rear mounting bracket axis 338 manually by applying an upward force to the seat frame assembly 300. In some embodiments, the vehicle 10 may utilize the same motor to pivot the seat frame assembly 300 about the front adjustment bracket axis 352 as used to slide the first slidable track 206 and the second slidable track 208 along the first base track 202 and the second base track 204 and/or rotate the back frame 304 relative to the seat frame 302 about the recline axis 308. The lifting and lowering of the rear end 104 of the seat frame assembly 300 using the rear adjustment module 330 may be defined or referred to as a fifth way of adjustment (e.g., the up position, the upward movement of the rear end 104 of the seat frame assembly 300, etc.) and a sixth way of adjustment (e.g., a down position, the downward movement of the rear end 104 of the seat frame assembly 300, etc.).

In operation, the thigh bar 320 facilitates providing adjustments to the front cushion 54 of the bottom seat cushion 50. For example, as shown in FIG. 10, the seat frame assembly 300 can be reconfigurable from a base position where the thigh bar 230 is positioned beneath a top surface of the seat frame 302 to an increased thigh support position by moving (e.g., pivoting) the thigh bar 320 about the thigh bar axis 322 to lift the thigh bar 320 such that the thigh bar at least partially extends above the top surface of the seat frame 302. The thigh support position may allow for increased support of the occupant's thighs. In some embodiments, the thigh bar 320 is pivoted about the thigh bar axis 322 through the use of a motor. In some embodiments, the thigh bar 320 is pivoted about the thigh bar axis 322 manually by applying a force to the thigh bar 320 (e.g., via a manual actuator, lever, etc.). In some embodiments, the thigh bar 320 is pivoted about the thigh bar axis 322 when an occupant activates or engages a user interface (e.g., pressing a first button to rotate the thigh bar 320 in a first direction, pressing a second button to rotate the thigh bar 320 in a second direction, etc.). The pivoting of the thigh bar 320 about the thigh bar axis 322 may be defined or referred to as a seventh way of adjustment (e.g., the upward rotation of the thigh bar 320, etc.) and an eighth way of adjustment (e.g., the downward rotation of the thigh bar 320, etc.).

In operation, the front adjustment module 400 facilitates providing lounge adjustment (with constant or varying h-point center). For example, as shown in FIG. 12, the seat frame assembly 300 can be reconfigurable into a lounge position or orientation from the base position by manipulating the front adjustment module 400. More specifically, the first lower linkage 430 and the second lower linkage 520 pivot about the front mounting bracket axis 424, causing the front adjustment brackets 350 to pivot about the front adjustment bracket axis 352 and the front adjustment module axis 360 such that the front end 102 of the seat frame assembly 300 is lifted and the rear end 104 of the seat frame assembly 300 pivots about the rear linkage axis 334 such that the seat frame assembly 300 is angled backwards relative to the base position. The lounge adjustment may allow the occupant to lean their body backward while occupying the seat 40, which may be a more comfortable position for the occupant. As shown in FIGS. 14, the electric motor 418 extends the actuator arm 420 to manipulate the front adjustment module 400 to cause the seat frame assembly 300 to pivot about the rear linkage axis 334 and the front end 102 thereof to lift. In some embodiments, the electric motor 418 engages the front adjustment module 400 when an occupant activates a user interface (e.g., pressing a first button to lift the front end 102 of the seat frame assembly 300 in a first direction, pressing a second bottom to lower the front end 102 of the seat frame assembly 300 in a second direction, etc.). In other embodiments, the front adjustment module 400 is manually manipulated by applying a force to the seat frame assembly 300. The lifting and lowering of the front end 102 of the seat frame assembly 300 using the front adjustment module 400 may be defined or referred to as a ninth way of adjustment (e.g., the lounge position, the upward movement of the front end 102 of the seat frame assembly 300, etc.) and a tenth way of adjustment (e.g., the downward movement of the front end 102 of the seat frame assembly 300, etc.).

In operation, the footrest 306 is repositionable between a plurality of orientations. For example, as shown in FIGS. 21-23, the footrest 306 can be repositionable between a stowed or retracted orientation (see FIG. 21), a deployed orientation (see FIG. 22), and an extended orientation (see FIG. 23). According to the exemplary embodiment shown in FIG. 21, when in the stowed orientation, the footrest 306 is angled downward or folded down proximate the front end 102 of the seat frame assembly 300 with the footrest extension 610 disposed along the footrest base 600. As another example, as shown in FIGS. 4 and 25, the footrest 306 can be repositionable between a stowed or retracted orientation (see FIG. 4) and an extended orientation (see FIG. 25). According to the exemplary embodiment shown in FIG. 4, when in the stowed orientation, the footrest 306 is angled downward or folded down proximate the front end 102 of the seat frame assembly 300 with the footrest support 700 disposed along the third linkages 688, the third linkages 688 disposed along the first linkages 682, the fifth linkages 692 disposed along the fourth linkages 690, and the fourth linkages 690 disposed along the second linkages 684. In some embodiments, the footrest 306 moves to the stowed orientation when an occupant activates or engages a user interface (e.g., presses a button, pulls a lever, taps a portion of a touch screen, etc.). In other embodiments, the occupant can manually move the footrest 306 to the stowed position (e.g., by applying forces to different components of the footrest 306, etc.).

According to the exemplary embodiment shown in FIG. 22, the footrest 306 is reconfigurable into the deployed orientation by rotating or unfolding the footrest 306 about the footrest axis 602 such that the footrest 306 is pivots upward from the stowed orientation. The deployed orientation may allow the occupant to rest their legs against the footrest base 600 while occupying the seat 40, which may be a more comfortable position for the occupant. In some embodiments, the footrest base 600 moves to the deployed orientation when an occupant activates a user interface (e.g., presses a button, pulls a lever, taps a portion of a touch screen, etc.). In other embodiments, the occupant may manually move the footrest base 600 to the outward position (e.g., by applying forces to the footrest base 600, engaging a manual actuator, etc.). In some embodiments, the footrest 306 is automatically reconfigured into the deployed orientation when the seat frame assembly 300 is reconfigured into the lounge position. In some embodiments, the footrest 306 is reconfigurable into the deployed orientation when the seat frame assembly 300 is in other positions (e.g., the base position, the reclined position, etc.). In still other embodiments, the footrest base 600 moves relative to the seat frame 302 in a way other than rotation (e.g., extends linearly, pivot about a linkage, roll outward, etc.). The rotation of the footrest 306 about the footrest axis 602 may be defined or referred to as an eleventh way of adjustment (e.g., the rotation of the footrest 306 such that it extends from the seat frame 302, etc.) and a twelfth way of adjustment (e.g., the rotation of the footrest 306 such that it contracts towards the seat frame 302, etc.).

According to the exemplary embodiment shown in FIG. 23, the footrest 306 is reconfigurable into the extended orientation by moving (e.g., pivoting, translating, etc.) the footrest extension 610 relative to the footrest base 600 such that the footrest extension 610 extends in front of the footrest base 600. In some embodiments, the footrest extension 610 pivots about the footrest extension axis 604 so that the footrest extension 610 pivots relative to the footrest base 600 to provide the extended orientation. In some embodiments, the footrest extension 610 translates relative to the footrest base 600 to provide the extended orientation. The extended orientation may allow the occupant to rest their legs against the footrest base 600 and their feet against the footrest extension 610, which may be a more comfortable position for the occupant. In some embodiments, the footrest base 600 and the footrest extension 610 move to the extended orientation when an occupant activates a user interface (e.g., presses a button, pulls a lever, taps a portion of a touch screen, etc.). In other embodiments, the occupant can manually move the footrest base 600 and the footrest extension 610 to the extended position (e.g., by applying forces to the footrest base 600 and the footrest extension 610, etc.). In some embodiments, the footrest 306 automatically reconfigures into the extended orientation when the seat frame assembly 300 is reconfigured into the lounge position. In some embodiments, the footrest 306 can be reconfigured in the extended orientation when the seat frame assembly 300 is in other positions (e.g., the base position, the reclined position, etc.). The movement of the footrest extension 610 may be defined as a thirteenth way of adjustment (e.g., the movement of the footrest extension 610 such that it extends from the footrest base 600, etc.) and a fourteenth way of adjustment (e.g., the movement of the footrest extension 610 such that it contracts or retracts toward the footrest base 600, etc.).

According to the exemplary embodiment shown in FIG. 25, the footrest 306 is reconfigurable into the extended orientation by moving (e.g., translating, extending, etc.) the footrest support 700 relative to the seat frame 302. By way of example, the footrest 306 may be reconfigurable into the extended orientation by manipulating the linkage assembly 680. More specifically, the first lower linkage 430 and the second lower linkage 520 pivot relative to the first mounting bracket 410 and the second mounting bracket 510, respectively, causing the extension bracket 660 to pivot upward relative to the first mounting bracket 410 and the second mounting bracket 510 via the crossbar 550. As the extension bracket 660 pivots upward, the linkage bar 686 moves along the extension apertures 662 from a rearward end of the extension apertures 662 to a forward end of the extension apertures 662, which causes the linkage bar 686 to move along the pivot apertures 672 from a lower end of the pivot apertures 672 to an upper end of the pivot apertures 672 such that the first end of the second linkages 684 moves toward the first end of the first linkages 682. The movement of the first end of the second linkages 684 toward the first end of the first linkages 682 causes the first linkages 682 to pivot relative to the second linkages 684 and the distal ends of the first linkages 682 to move towards the distal ends of the second linkages 684 while the distal ends of the first linkages 682 and the distal ends of the second linkages 684 move away from the pivot brackets 670. Similarly, the movement of the first linkages 682 and the second linkages 684 cause third linkages 688 to pivot relative to the fourth linkages 690 and the distal ends of the third linkages 688 to move towards the distal ends of the fourth linkages 690 while the distal ends of the third linkages 688 and the distal ends of the fourth linkages 690 move away from the pivot brackets 670 such that the fifth linkages 692 pivot the footrest support 700 upward relative to the fourth linkages 690 while the components of the linkage assembly 680 move the footrest support 700 away from the pivot brackets 670. The extended orientation may allow for the occupant to rest their legs and/or their feet against the footrest support 700 while occupying the seat 40, which may be a more comfortable position for the occupant.

In some embodiments, the electric motor 418 pivots the first lower linkage 430 relative to the first mounting bracket 410 to cause the footrest 306 to extend the footrest support 700 away from the seat frame 302 and cause the footrest support 700 to pivot relative to the fourth linkages 690 and a front end thereof to lift. For example, the electric motor 418 may pivot the first lower linkage 430 relative to the first mounting bracket 410 to reconfigure the footrest 306 into the extended orientation and reconfigure the seat frame assembly 300 into the lounge position or orientation from the base position. In some embodiments, the electric motor 418 pivots the first lower linkage 430 relative to the first mounting bracket 410 to extend the footrest support 700 when an occupant activates a user interface (e.g., presses a first button to move the footrest support 700 in a first direction relative to the seat frame 302, presses a second button to move the footrest support 700 in a second direction relative to the seat frame 302, pulling a lever, tapping a portion of a touch screen, etc.). In other embodiments, the footrest 306 is manually manipulated by applying a force to the footrest 306. The movement of the footrest support 700 relative to the seat frame 302 may be defined or referred to an eleventh way of adjustment (e.g., the movement of the footrest support 700 such that it extends from the seat frame 302, etc.) and a twelfth way of adjustment (e.g., the movement of the footrest support 700 such that it contracts towards the seat frame 302, etc.).

According to an exemplary embodiment, the frame assembly 100 is reconfigurable into a comfort lounge orientation by at least pivoting the back frame 304 backwards about the recline axis 308, pivoting the front end 102 of the seat frame assembly 300 upward with the front adjustment module 400, and moving the footrest 306 into the extended orientation, as shown in FIGS. 13, 23, and 25. The comfort lounge orientation may allow the occupant to position their body in a recumbent and laying orientation when the occupant is occupying the seat 40. In some instances, engaging the comfort lounge orientation may also include sliding the first slidable track 206 and the second slidable track 208 rearward along the first base track 202 and the second base track 204, respectively, to ensure that the reconfiguration of the footrest 306 to the deployed and/or extended orientation does not cause contact between the seat 40 and other internal components of the vehicle 10 (e.g., the dashboard, the steering wheel, the footwell, etc.). According to an exemplary embodiment, the front seat 42 is reconfigurable to provide the comfort lounge orientation such that a driver of the vehicle 10 may position their body in the recumbent position when the driver is not operating (e.g., not driving, etc.) the vehicle 10. Such a front seat 42 may advantageously allow the driver to rest (e.g., sleep, nap, etc.) more comfortably between events requiring the operation of the vehicle 10 (e.g., between deliveries, between ridesharing events, while waiting for passengers to become available, while the vehicle 10 is charging, etc.), which may increase the wakefulness and the efficiency of the driver when operating the vehicle 10. In Some embodiments, the rear seats 44 are additionally or alternatively configured to be placed into the comfort lounge orientation.

As utilized herein, the terms “approximately,” “about,” “relatively,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the seat 40 and components thereof (e.g., the frame assembly 100, etc.) as shown in the various exemplary embodiments is illustrative only. Additionally, any element disclosed in one embodiment may be incorporated or utilized with any other embodiment disclosed herein.

1. An adjustable lounge seat for a vehicle, the adjustable lounge seat comprising:
a seat frame having a front end and a rear end;
a back frame pivotably coupled to the rear end of the seat frame;
a first assembly coupled to the seat frame proximate the rear end thereof and configured to couple to a track assembly, the first assembly configured to facilitate moving the rear end of the seat frame up and down;
a second assembly coupled to the seat frame proximate the front end thereof and configured to couple to the track assembly, the second assembly configured to facilitate moving the front end of the seat frame up and down;
a footrest coupled to the front end of the seat frame and the second assembly, the footrest is movable between a stowed orientation and an extended orientation; and
an actuator configured to actuate the second assembly and, thereby, the footrest.

2. The adjustable lounge seat of claim 1, wherein the second assembly includes:
a first bracket configured to couple to the track assembly;
a second bracket configured to couple to the track assembly;
a first linkage pivotably coupled to the first bracket;
a second linkage pivotably coupled to the second bracket;
a third bracket pivotably coupled to the first linkage and pivotably coupled to the seat frame; and
a fourth bracket pivotably coupled to the second linkage and pivotably coupled to the seat frame.

3. The adjustable lounge seat of claim 2, wherein the footrest includes:
a fifth bracket coupled to the first linkage and the second linkage, the fifth bracket positioned between the first linkage and the second linkage;
a sixth bracket coupled to the seat frame;
a seventh bracket coupled to the seat frame;
a linkage assembly having (a) a first portion pivotably coupled to the sixth bracket and the seventh bracket and (b) a second portion movably coupled to the fifth bracket, the sixth bracket, and the seventh bracket; and
a footrest base pivotably coupled to a distal end of the linkage assembly;
wherein the footrest base is movable between (a) the stowed orientation where the footrest base is folded down proximate the front end of the seat frame and (b) the extended orientation where the footrest base is extended forward from the seat frame by the linkage assembly.

4. The adjustable lounge seat of claim 3, wherein the linkage assembly includes:
a plurality of linkages extending between (a) the sixth bracket and the seventh bracket and (b) the footrest base; and
a plurality of linkage axles pivotably coupling the plurality of linkages and extending between the plurality of linkages.

5. The adjustable lounge seat of claim 4, wherein:
the fifth bracket defines a first slot;
the sixth bracket defines a second slot;
the seventh bracket defines a third slot; and
one of the plurality of linkage axles aligns with and is received by the first slot, the second slot, and the third slot.

6. The adjustable lounge seat of claim 1, wherein the footrest includes:
a footrest base movably coupled to the front end of the seat frame; and
a footrest extension movably coupled to the footrest base;
wherein the footrest is movable between (a) the stowed orientation where the footrest base and the footrest extension are folded down proximate the front end of the seat frame, (b) a deployed orientation where the footrest base and the footrest extension are unfolded and extend forward of the front end of the seat frame, and (c) the extended orientation where the footrest extension extends forward of the footrest base.

7. The adjustable lounge seat of claim 1, further comprising a pin coupled to the seat frame, wherein the third bracket defines a slot configured to align with and receive the pin to partially constrain movement of the third bracket relative to the seat frame and guide the movement thereof.

8. The adjustable lounge seat of claim 1, wherein the second assembly includes a crossbar (a) pivotably coupling the first linkage to the third bracket, (b) pivotably coupling the second linkage to the fourth bracket, and (c) extending between the first linkage and the second linkage.

9. The adjustable lounge seat of claim 1, wherein the adjustable lounge seat is configured to be a front seat of the vehicle for supporting a driver of the vehicle.

10. The adjustable lounge seat of claim 1, wherein the footrest including an extendable scissor assembly.

11. The adjustable lounge seat of claim 1, further comprising a thigh bar movably coupled to the front end of the seat frame.

12. An adjustable lounge seat for a vehicle, the adjustable lounge seat comprising:
a seat frame assembly configured to couple to a track assembly, the seat frame assembly including:
a seat frame having a front end and a rear end;
a back frame pivotably coupled to the rear end of the seat frame;
a first assembly coupled to the seat frame proximate the rear end thereof and configured to couple to the track assembly, the first assembly configured to facilitate moving the rear end of the seat frame up and down;
a second assembly coupled to the seat frame proximate the front end thereof and configured to couple to the track assembly, the second assembly configured to facilitate moving the front end of the seat frame up and down; and
a footrest coupled to the front end of the seat frame, the footrest movable between a stowed orientation and an extended orientation, the footrest comprising:
a first bracket coupled to the second assembly, the first bracket defining a first slot;
a second bracket coupled to the seat frame, the second bracket defining a second slot;
a third bracket coupled to the seat frame, the third bracket defining a third slot;
a linkage assembly including:
a plurality of linkages including at least a first set of linkages and a second set of linkages; and
a plurality of linkage axles including (a) a first linkage axle pivotably coupling the first set of linkages to the second set of linkages, (b) a second linkage axle pivotably coupling the first set of linkages to the second bracket and the third bracket, and (c) a third linkage axle extending through the second set of linkages and received by the first slot, the second slot, and the third slot; and
a footrest support pivotably coupled to a distal end of the linkage assembly.

13. The adjustable lounge seat of claim 12, wherein:
the second bracket defines a first aperture;
the third bracket defines a second aperture; and
a second of the linkage axles aligns with and is received by the first aperture and the second aperture to pivotably couple the linkage assembly to the second bracket and the third bracket.

14. The adjustable lounge seat of claim 13, wherein:
the first of the linkage axles is coupled to a first of the linkages;
the second of the linkage axles is coupled to a second of the linkages; and
the first of the linkages and the second of the linkages are pivotably coupled by a third of the linkage axles.

15. The adjustable lounge seat of claim 12, wherein the second assembly comprises:
a fourth bracket configured to couple to the track assembly;
a fifth bracket configured to couple to the track assembly;
a first linkage pivotably coupled to the fourth bracket and coupled to the first bracket;
a second linkage pivotably coupled to the fifth bracket and coupled to the first bracket;
a sixth bracket pivotably coupled to the first linkage and pivotably coupled to the seat frame; and
a seventh bracket pivotably coupled to the second linkage and pivotably coupled to the seat frame.

16. The adjustable lounge seat of claim 15, further comprising a pin coupled to the seat frame, wherein the sixth bracket defines a slot configured to align with and receive the pin to partially constrain movement of the sixth bracket relative to the seat frame and guide the movement thereof.

17. A seat adjustment assembly (a) configured to couple to a seat frame of an adjustable lounge seat for a vehicle proximate a front end of the seat frame and (b) configured to couple to a track assembly, the seat adjustment assembly configured to facilitate moving the front end of the seat frame up and down, the seat adjustment assembly including:
a first bracket configured to couple to the track assembly;
a second bracket configured to couple to the track assembly;
a first linkage pivotably coupled to the first bracket;
a second linkage pivotably coupled to the second bracket;
a third bracket pivotably coupled to the first linkage and configured to pivotably couple to the seat frame; and
a fourth bracket pivotably coupled to the second linkage and configured to pivotably couple to the seat frame.

18. The seat adjustment assembly of claim 17, further comprising:
a footrest configured to couple to the front end of the seat frame, the footrest movable between a stowed orientation and an extended orientation, the footrest including:
a fifth bracket coupled to the first linkage and the second linkage, the fifth bracket positioned between the first linkage and the second linkage;
a sixth bracket coupled to the seat frame;
a seventh bracket coupled to the seat frame;
a linkage assembly having (a) a first portion pivotably coupled to the sixth bracket and the seventh bracket and (b) a second portion movably coupled to the fifth bracket, the sixth bracket, and the seventh bracket; and
a footrest base pivotably coupled to a distal end of the linkage assembly;
wherein the footrest base is movable between (a) the stowed orientation where the footrest base is folded down proximate the front end of the seat frame and (b) the extended orientation where the footrest base is extended forward from the seat frame by the linkage assembly.

19. The seat adjustment assembly of claim 18, wherein:
the linkage assembly includes:
a plurality of linkages extending between (a) the sixth bracket and the seventh bracket and (b) the footrest base; and
a plurality of linkage axles pivotably coupling the plurality of linkages and extending between the plurality of linkages;
the fifth bracket defines a first slot;
the sixth bracket defines a second slot;
the seventh bracket defines a third slot; and
one of the plurality of linkage axles aligns with and is received by the first slot, the second slot, and the third slot.

20. The seat adjustment assembly of claim 18, further comprising at least one of:
a crossbar (a) pivotably coupling the first linkage to the third bracket, (b) pivotably coupling the second linkage to the fourth bracket, (c) coupling the first linkage to the fifth bracket, (d) coupling the second linkage to the fifth bracket, and (e) extending between the first linkage and the second linkage; or
an actuator coupled to the first bracket, the actuator configured to drive the first linkage to (a) move the front end of the seat frame up and down and (b) move the footrest between the stowed orientation and the extended orientation.
